(19) United States
(12) Patent Application Publication
(10) Pub. No.: US 2016/0325680 A1
(43) Pub. Date: Nov. 10, 2016

(54) SYSTEM AND METHOD OF VEHICLE SENSOR MANAGEMENT

(71) Applicant: Kamama, Inc., Scotts Valley, CA (US)

(72) Inventors: Robert Curtis, Scotts Valley, CA (US); Saket Vora, Scotts Valley, CA (US); Brian Sander, Scotts Valley, CA (US); Joseph Fisher, Scotts Valley, CA (US); Bryson Gardner, Scotts Valley, CA (US); Tyler Mincey, Scotts Valley, CA (US); Ryan Du Bois, Scotts Valley, CA (US); Erturk Kocalar, Scotts Valley, CA (US); David Shoemaker, Scotts Valley, CA (US); Jorge Fino, Scotts Valley, CA (US)

(21) Appl. No.: 15/146,705

(22) Filed: May 4, 2016

Related U.S. Application Data
(60) Provisional application No. 62/156,411, filed on May 4, 2015.
(60) Provisional application No. 62/215,578, filed on Sep. 8, 2015.

(51) Int. Cl. B60R 1/00; H04N 5/232; H04L 29/08; H04N 7/18; H04N 5/262; H04N 5/265; H04N 5/247; H04N 5/77

(52) U.S. Cl. CPC B60R 1/00; H04N 5/247; H04N 5/23238; H04N 5/77; H04N 7/181; H04N 5/23241; H04N 5/2628; H04N 5/23216; H04N 5/265; H04L 67/12; B60R 2300/50; G06T 2210/22

(57) ABSTRACT

A method for vehicle sensor management including: acquiring sensor measurements at a sensor module; transmitting the sensor measurements from the sensor module; processing the sensor measurements; and transmitting the processed sensor measurements to a client associated with the vehicle, wherein the processed sensor measurements are rendered by the client on the user device.

### CROSS-REFERENCE TO RELATED APPLICATIONS

This application claims the benefit of U.S. Provisional Application No. 62/156,411 filed 4 May 2015 and U.S. Provisional Application No. 62/215,578 filed 8 Sep. 2015, which are incorporated in their entireties by this reference.

### TECHNICAL FIELD

This invention relates generally to the vehicle sensor field, and more specifically to a new and useful system and method for vehicle sensor management in the vehicle sensor field.

### BRIEF DESCRIPTION OF THE FIGURES

FIG. 1 is a flowchart diagram of the method of vehicle sensor management system operation.

FIG. 2 is a schematic representation of the vehicle sensor management system.

FIG. 3 is a perspective view of a variation of the sensor module mounted to a vehicle.

FIG. 4 is a perspective view of a variation of the hub.

FIG. 5 is a schematic representation of different types of connections that can be established between a specific example of the sensor module, hub, and user device.

FIG. 6 is a schematic representation of a specific example of the vehicle sensor management system operation between the low-power sleep mode, low-power standby mode, and streaming mode.

FIG. 7 is a schematic representation of data and power transfer between the sensor module, hub, user device, and remote computing system, including streaming operation and system updating.

FIG. 8 is a schematic representation of a specific example of sensor measurement processing and display.

FIG. 9 is an example of user stream and user notification display, including a highlight example and a callout example.

FIG. 10 is an example of user stream and user notification display, including a range annotation on the user stream and a virtual representation of the spatial region shown by the user stream.

FIG. 11 is a third example of user stream and user notification display.

FIG. 12 is a fourth example of user stream and user notification display, including a parking assistant.

FIG. 13 is an example of background stream and user stream compositing.

FIG. 14 is a specific example of background stream and user stream compositing, including 3D scene generation.

FIG. 15 is a specific example of user view adjustment and accommodation.

FIG. 16 is a specific example of notification module updating based on the notification and user response.

FIG. 17 is a specific example of selective sensor module operation based on up-to-date system data.

FIG. 18 is a schematic representation of updating multiple systems.

FIG. 19 is a schematic representation of a variation of the sensor module.

FIG. 20 is a schematic representation of a variation of the hub.

FIG. 21 is a schematic representation of a specific example of vehicle sensor management system operation.

FIG. 22 is a schematic representation of a variation of the system including a sensor module and a hub.

FIG. 23 is a schematic representation of a variation of the system including a sensor module and a user device.

FIG. 24 is a schematic representation of a variation of the system including multiple sensor modules.

FIG. 25 is a specific example of sensor measurement processing.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. Overview.

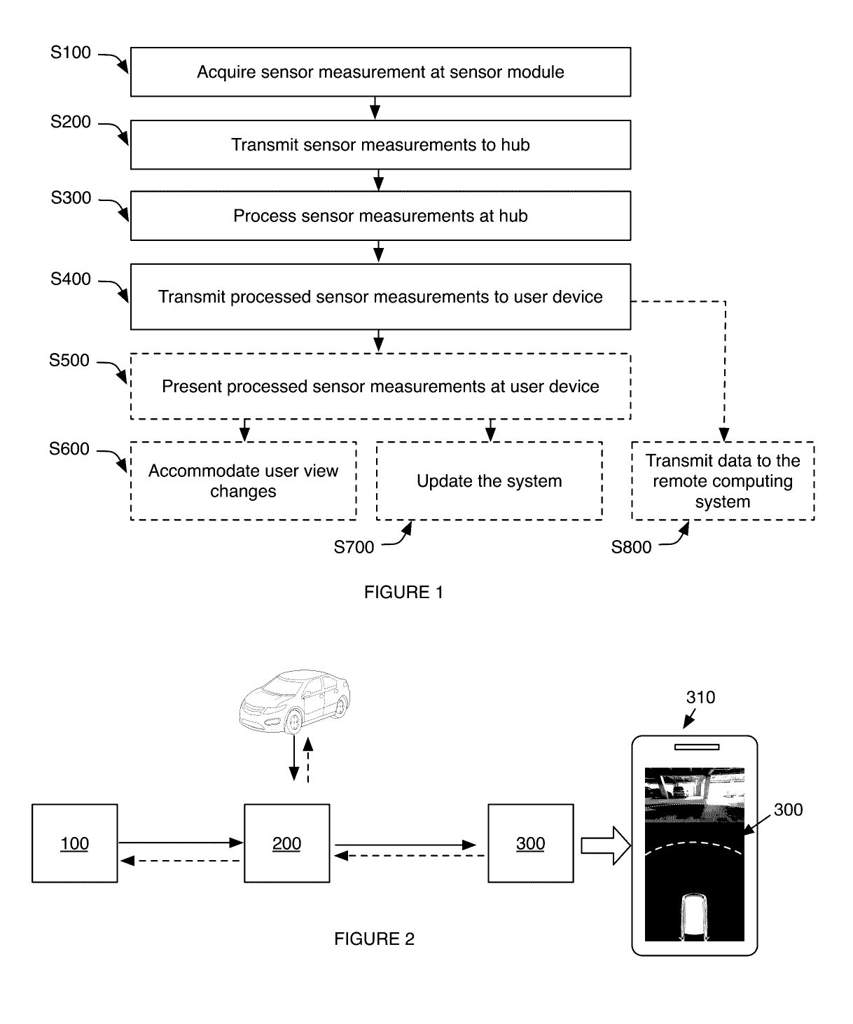

As shown in FIG. 1, the method for vehicle sensor management includes: acquiring sensor measurements at a sensor module S100; transmitting the sensor measurements from the sensor module S200; processing the sensor measurements S300; and transmitting the processed sensor measurements to a client, wherein the processed sensor measurements are rendered by the client on the user device S400. The method functions to provide a user with real- or near-real time data about the vehicle environment. The method can additionally function to automatically analyze the sensor measurements, identify actions or items of interest, and annotate the vehicle environment data to indicate the actions or items of interest on the user view. The method can additionally include: selectively establishing communication channels between the sensor module, hub, and/or user device; responding to user interaction with the user interface; or support any other suitable process.

### 2. Benefits

This method can confer several benefits over conventional systems.

First, the method and system enables a user to easily retrofit a vehicle that has not already been wired for external sensor integration and/or expansion. The method can enable easy installation by wirelessly transmitting all data between the sensor module, hub, and/or user device. For example, sensor measurements (e.g., video, audio, etc.) can be transmitted between the sensor module, hub, and/or user device through a high-bandwidth wireless connection, such as a WiFi network. In a specific example, the hub can function as an access point and create (e.g., host) the local wireless network, wherein the user device and sensor module wirelessly connect to the hub. The hub can function to leverage a component connected to a reliable, continuous power source (e.g. the vehicle, via the vehicle bus or other power port). In a second example, control instructions (e.g., sensor module adjustment instructions, mode instructions, etc.) can be transmitted between the sensor module, hub, and/or user device through a low-bandwidth wireless connection, such as a Bluetooth network.

Second, the inventors have discovered that certain processes, such as object identification, can be resource-intensive. These resource-intensive processes require time, resulting in video display delay; and power, resulting in high power consumption. These issues, particularly the latter, can be problematic for retrofit systems, which run on secondary power sources (e.g., batteries, decoupled from a constant power source). Variations of this method can resolve these issues by splitting image processing into multiple sub-processes (e.g., user stream generation, object identification, and notification compositing) and by performing the sub-processes asynchronously with different system components.

The method can reduce the delay resulting from object identification and/or other resource-intensive processes (e.g., enable near-real time video display) by processing the raw sensor data (e.g., video stream(s)) into a user stream at the sensor module and passing the user stream through to user device, independent of object identification. The method can further reduce the delay by applying (e.g., overlaying) graphics to asynchronous frames (e.g., wherein alerts generated based on a first set of video frames are overlaid on a subsequent set of video frames); this allows up-to-date video to be displayed, while still providing notifications (albeit slightly delayed). The inventors have discovered that users can find real- or near-real time vehicle environment data (e.g., a real-time video stream) more valuable than delayed vehicle environment data with synchronous annotations. The inventors have also discovered that users do not notice a slight delay between the vehicle environment data and the annotation. By generating and presenting annotation overlays asynchronously from sensor measurement presentation, the method enables both real- or near-real time vehicle environment data provision and vehicle environment data annotations (albeit slightly delayed or asynchronous). Furthermore, because the annotations are temporally decoupled from the vehicle environment data, annotation generation is permitted more time. This permits the annotation to be generated from multiple data streams, which can result in more accurate and/or contextually-relevant annotations.

The method can further reduce delay by pre-processing the sensor data (e.g., captured video frames) with dedicated hardware, which can process data faster than analogous software. For example, the sensor module can include dedicated dewarping circuitry that dewarps the video frames prior to user stream generation. However, the method can otherwise decrease the delay between sensor measurement acquisition (e.g., recordation) and presentation at the user device.

The method can reduce the power consumption of components that do not have a constant power supply (e.g., the sensor module and user device) by localizing resource-intensive processes on a component electrically connected to a constant source of power during system operation (e.g., the vehicle).

The method can reduce (e.g., minimize) the time between sensor measurement capture (e.g., video capture) and presentation, to provide a low latency, real- or near-real time sensor feed to the user by performing all or most of the processing on the components located on or near the vehicle.

Third, the method can enable continual driving recommendation learning and refinement by remotely monitoring the data produced by the sensor module (e.g., the raw sensor measurements, processed sensor measurements, such as the analysis stream and user stream, etc.), the notifications (e.g., recommendations) generated by the hub, and the subsequent user responses (e.g., inferred from vehicle operation parameters received from the hub, user device measurements, etc.) at the remote computing system. For example, the method can track and use this information to train a recommendation module for a user account population and/or single user account.

Fourth, the method can leverage the user devices (e.g., the clients running on the user devices) as an information gateway between the remote computing system and the vehicle system (e.g., hub and sensor module). This can allow the remote computing system to concurrently manage (e.g., update) a plurality of vehicle systems, to concurrently monitor and learn from a plurality of vehicle systems, and/or to otherwise interact with the plurality of vehicle systems. This can additionally allow the remote computing system to function as a telemetry system for the vehicle itself. For example, the hub can read vehicle operation information off the vehicle bus and send the vehicle operation information to the user device, wherein the user device sends the vehicle operation information to the remote computing system, which tracks the vehicle operation information for the vehicle over time.

Fifth, in some variations, the video displayed to the user is a cropped version of the raw video. This can confer the benefits of: decreasing latency (e.g., decreasing processing time) because a smaller portion of the video needs to be de-warped, and focusing the user on a smaller field of view to decrease distractions.

Sixth, in variations in which the hub receives vehicle operation data, the method can confer the benefit of generating more contextually-relevant notifications, based on the vehicle operation data.

### 3. System

As shown in FIG. 2, this method is preferably performed by a sensor module 100, hub 200, and client 300, and can additionally be used with a remote computing system (e.g., remote server system). However, the method can be performed with any other set of computing systems. The sensor module 100, hub 200, and user device 310 running the client 300 are preferably separate and distinct systems (e.g., housed in separate housings), but a combination of the above can alternatively be housed in the same housing. In some variations, the hub 200, client 300, and/or remote computing system 400 can be optional.

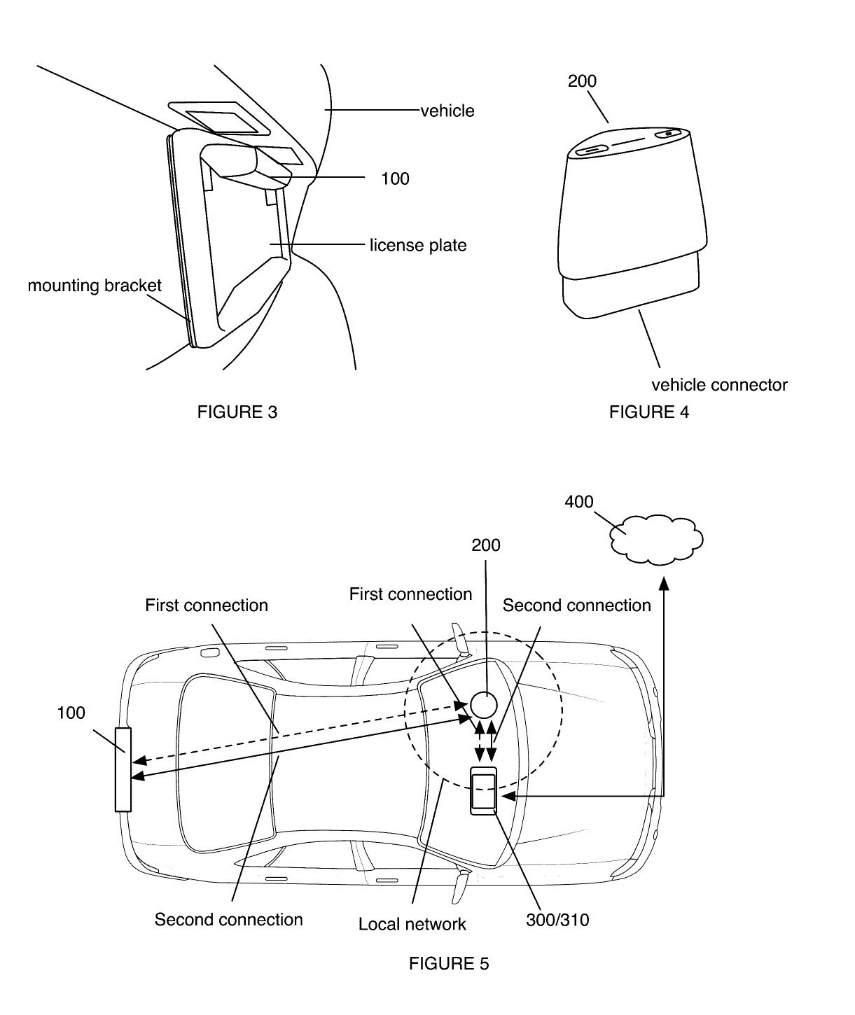

The sensor module 100 of the system functions to record sensor measurements indicative of the vehicle environment and/or vehicle operation. As shown in FIG. 3, the sensor module (e.g., imaging system) is configured to mount to the vehicle (e.g., vehicle exterior, vehicle interior), but can alternatively be otherwise arranged relative to the vehicle. In one example, the sensor module can record images, video, and/or audio of a portion of the vehicle environment (e.g., behind the vehicle, in front of the vehicle, etc.). In a second example, the sensor module can record proximity measurements of a portion of the vehicle (e.g., blind spot detection, using RF systems). The sensor module can include a set of sensors (e.g., one or more sensors), a processing system, and a communication module (example shown in FIG. 19). However, the sensor module can include any other suitable component. The sensor module is preferably operable between a standby and streaming mode, but can alternatively be operable in any other suitable mode. The system can include one or more sensor modules of same or differing type (example shown in FIG. 24).

The set of sensors function to record measurements indicative of the vehicle environment. Examples of sensors that can be included in the set of sensors include: cameras (e.g., stereoscopic cameras, multispectral cameras, hyperspectral cameras, etc.) with one or more lenses (e.g., fisheye lens, wide angle lens, etc.), temperature sensors, pressure sensors, proximity sensors (e.g., RF transceivers, radar transceivers, ultrasonic transceivers, etc.), light sensors, audio sensors (e.g., microphones), orientation sensors (e.g., accelerometers, gyroscopes, etc.), or any other suitable set of sensors. The sensor module can additionally include a signal emitter that functions to emit signals measured by the sensors (e.g., when an external signal source is insufficient). Examples of signal emitters include light emitters (e.g., lighting elements), such as white lights, IR lights, RF, radar, or ultrasound emitters, audio emitters (e.g., speakers, piezoelectric buzzers), or include any other suitable set of emitters.

The processing system of the sensor module 100 functions to process the sensor measurements, and control sensor module operation (e.g., control sensor module operation state, power consumption, etc.). For example, the processing system can dewarp and compress (e.g., encode) the video recorded by a wide angle camera. The wide angle camera can include a camera with a rectilinear lens, a fisheye lens, or any other suitable lens. In another example, the processing system can process (e.g., crop) the recorded video based on a pan/tilt/zoom selection (e.g., received from the hub or user device). In another example, the processing system can encode the sensor measurements (e.g., video frames), wherein the hub and/or user device can decode the sensor measurements. The processing system can be a microcontroller, microprocessor, CPU, GPU, a combination of the above, or any other suitable processing unit. The processing system can additionally include dedicated hardware (e.g., video dewarping chips, video encoding chips, video processing chips, etc.) that reduces the sensor measurement processing time.

The communication module functions to communicate information, such as the raw and/or processed sensor measurements, to an endpoint. The communication module can be a single radio system, multiradio system, or support any suitable number of protocols. The communication module can be a transceiver, transmitter, receiver, or be any other suitable communication module. The communication module can be wired (e.g., cable, optical fiber, etc.), wireless, or have any other suitable configuration. Examples of communication module protocols include short-range communication protocols, such as BLE, Bluetooth, NFC, ANT+, UWB, IR, and RF, long-range communication protocols, such as WiFi, Zigbee, Z-wave, radio, and cellular, or support any other suitable communication protocol. In one variation, the sensor module can support one or more low-power protocols (e.g., BLE and Bluetooth), and support a single high- to mid-power protocol (e.g., WiFi). However, the sensor module can support any suitable number of protocols.

In one variation, the sensor module 100 can additionally include an on-board power source (e.g., secondary or rechargeable battery, primary battery, energy harvesting system, such as solar and wind, etc.), and function independently from the vehicle. This variation can be particularly conducive to aftermarket applications (e.g., vehicle retrofitting), in which the sensor module can be mounted to the vehicle (e.g., removably or substantially permanently), but not rely on vehicle power or data channels for operation. However, the sensor module can be wired to the vehicle, or be connected to the vehicle in any other suitable manner.

The hub 200 of the system functions as a communication and processing hub for facilitating communication between the user device and sensor module. The hub (e.g., processing system) can include a vehicle connector, a processing system and a communication module, but can alternatively or additionally include any other suitable component (example shown in FIG. 20). FIG. 4 depicts an example of the hub.

The vehicle connector of the hub functions to electrically (e.g., physically) connect to a monitoring port of the vehicle, such as to the OBDII port or other monitoring port, such that the hub can draw power and/or information from the vehicle (e.g., via the port). Additionally or alternatively, the vehicle connector can be configured to connect to a vehicle bus (e.g., a CAN bus, LIN bus, MOST bus, etc.), such that the hub can draw power and/or information from the bus. The vehicle connector can additionally function to physically connect or mount (e.g., removably or permanently) the hub to the vehicle interior (e.g., the port). Alternatively, the hub can be a stand-alone system or be otherwise configured. More specifically, the vehicle connector can receive power from the vehicle and/or receive vehicle operation data from the vehicle. The vehicle connector is preferably a wired connector (e.g., physical connector, such as an OBD or OBDII connector), but can alternatively be a wireless communication module. The vehicle connector is preferably a data- and power-connector, but can alternatively be data-only, power-only, or have any other configuration. When the hub is connected to a vehicle monitoring port, the hub can receive both vehicle operation data and power from the vehicle. Alternatively, the hub can only receive vehicle operation data from the vehicle (e.g., wherein the hub can include an on-board power source), only receive power from the vehicle, transmit data to the vehicle (e.g., operation instructions, etc.), or perform any other suitable function.

The processing system of the hub functions to manage communication between the system components. The processing system can additionally function to manage security protocols, device pairing or unpairing, manage device lists, or otherwise manage the system. The processing system can additionally function as a processing hub that performs all or most of the resource-intensive processing in the method. For example, the processing system can: route sensor measurements from the sensor module to the user device, process the sensor measurements to extract data of interest (e.g., apply image or video processing techniques, such as dewarping and compressing video, comparing current and historical frames to identify differences, analyzing images to extract driver identifiers from surrounding vehicles, stitch or mosaicing video frames together, correcting for geometry, color, or any other suitable image parameter, generating 3D virtual models of the vehicle environment, processing sensor measurements based on vehicle operation data, etc.), generate user interface elements (e.g., warning graphics, notifications, etc.), control user interface display on the user device, or perform any other suitable functionality. The processing system can additionally generate control instructions for the sensor module and/or user device (e.g., based on user inputs received at the user device, vehicle operation data, sensor measurements, external data received from a remote system directly or through the user device, etc.), and send or control the respective system according to control instructions. Examples of control instructions include power state instructions, operation mode instructions, or any other suitable set of instructions. The processing system can be a microcontroller, microprocessor, CPU, GPU, combination of the above, or any other suitable processing unit. The processing system can additionally include dedicated hardware (e.g., video dewarping chips, video encoding chips) that reduces the data processing time. The processing system is preferably powered from the vehicle connector, but can alternatively or additionally be powered by an on-board power system (e.g., battery) or be otherwise powered.

The communication system of the hub functions to communicate with the sensor module and/or user device. The communication system can additionally or alternatively communicate with a remote processing system (e.g., remote server system, bypass the user device using a hub with a 3G communication module). The communication system can additionally function as a router or hotspot for one or more protocols, and generate one or more local networks. The communication system can be wired or wireless. In this variation, the sensor module and/or user device can connect to the local network generated by the hub, and use the local network to communicate data. The communication system can be a single radio system, multiradio system, or support any suitable number of protocols. The communication system can be a transceiver, transmitter, receiver, or be any other suitable communication system. Examples of communication system protocols include short-range communication protocols, such as BLE, Bluetooth, NFC, ANT+, UWB, IR, and RF, long-range communication protocols, such as WiFi, Zigbee, Z-wave, and cellular, or support any other suitable communication protocol. In one variation, the sensor module can support one or more low-power protocols (e.g., BLE and Bluetooth), and support a single high- to mid-power protocol (e.g., WiFi). However, the sensor module can support any suitable number of protocols. The communication system of the hub preferably shares at least two communication protocols with the sensor module—a low bandwidth communication channel and a high bandwidth communication channel, but can additionally or alternatively include any suitable number of low- or high-bandwidth communication channels. In one example, the hub and the sensor module can both support BLE, Bluetooth, and WiFi. The hub and user device preferably share at least two communication protocols as well (e.g., the same protocols as that shared by the hub and sensor module, alternatively different protocols), but can alternatively include any suitable set of communication protocols.

The client 300 of the system functions to associate the user device with a user account (e.g., through a login), connect the user device to the hub and/or sensor module, to receive processed sensor measurements from the hub or the sensor module, receive notifications from the hub, control sensor measurement display on a user device, receive operation instructions in association with the displayed data, and facilitate sensor module remote control based on the operation instructions. The client can optionally send sensor measurements to a remote computing system (e.g., processed sensor measurements, raw sensor measurements, etc.), receive vehicle operation parameters from the hub, send the vehicle operation parameters to the remote computing system, record user device operation parameters from the host user device, send the user device operation parameters to the remote computing system, or otherwise exchange (e.g., transmit) operation information to the remote computing system. The client can additionally function to receive updates for the hub and/or sensor module from the remote computing system and automatically update the hub and/or sensor module upon connection to the vehicle system. However, the client can perform any other suitable set of functionalities.

The client 300 is preferably configured to execute on a user device (e.g., remote from the sensor module and/or hub), but can alternatively be configured to execute on the hub, sensor module, or on any other suitable system. The client can be a native application (e.g., a mobile application), a browser application, an operating system application, or be any other suitable construct.

The client 300 can define a display frame or display region (e.g., digital structure specifying the region of the remote device output to display the video streamed from the sensor system), an input frame or input region (e.g., digital structure specifying the region of the remote device input at which inputs are received), or any other suitable user interface structure on the user device. The display frame and input frame preferably overlap, are more preferably coincident, but can alternatively be separate and distinct, adjacent, contiguous, have different sizes, or be otherwise related. The client 300 can optionally include an operation instruction module that functions to convert inputs, received at the input frame, into sensor module and/or hub operation instructions. The operation instruction module can be a static module that maps a predetermined set of inputs to a predetermined set of operation instructions; a dynamic module that dynamically identifies and maps inputs to operation instructions; or be any other suitable module. The operation instruction module can calculate the operation instructions based on the inputs, select the operation instructions based on the inputs, or otherwise determine the operation instructions. However, the client can include any other suitable set of components and/or sub-modules.

The user device 310 can include: a display or other user output, a user input (e.g., a touchscreen, microphone, or camera), a processing system (e.g., CPU, microprocessor, etc.), one or more communication systems (e.g., WiFi, BLE, Bluetooth, etc.), sensors (e.g., accelerometers, cameras, microphones, etc.), location systems (e.g., GPS, triangulation, etc.), power source (e.g., secondary battery, power connector, etc.), or any other suitable component. Examples of user devices include smartphones, tablets, laptops, smartwatches (e.g., wearables), or any other suitable user device.

The system can additionally include digital storage that functions to store the data processing code. The data processing code can include sensor measurement fusion algorithms, object detection algorithms, stereoscopic algorithms, motion algorithms, historic data recordation and analysis algorithms, video processing algorithms (e.g., de-warping algorithms), digital panning, tilting, or zooming algorithms, or any other suitable set of algorithms. The digital storage can be located on the sensor module, the hub, the mobile device, a remote computing system (e.g., remote server system), or on any other suitable computing system. The digital storage can be located on the system component using the respective algorithm, such that all the processing occurs locally. This can confer the benefits of faster processing and decrease reliance on a long-range communication system. Alternatively, the digital storage can be located on a different component from the processing component. For example, the digital storage can be in a remote server system, wherein the hub (e.g., the processing component) retrieves the required algorithms whenever data is to be processed. This can confer the benefits of using up-to-date processing algorithms. In a specific example, the algorithms can be locally stored on the processing component, wherein the sensor module stores digital pan/tilt/zoom algorithms (and includes hardware for video processing and compression); the hub stores the user input-to-pan/tilt/zoom instruction mapping algorithms, sensor measurement fusion algorithms, object detection algorithms, stereoscopic algorithms, and motion algorithms (and includes hardware for video processing, decompression, and/or compression); the user device can store rendering algorithms; and the remote computing system can store historic data acquisition and analysis algorithms and updated versions of the aforementioned algorithms for subsequent transmission and sensor module or hub updating. However, the algorithm storage and/or processing can be performed by any other suitable component.

The system can additionally include a remote computing system 400 that functions to remotely monitor sensor module performance; monitor data processing code efficacy (e.g., object identification accuracy, notification efficacy, etc.); determine and/or store user preferences; receive, generate, or otherwise manage software updates; or otherwise manage system data. The remote computing system can be a remote server system, a distributed network of user devices, or be otherwise implemented. The remote computing system preferably manages data for a plurality of system instances (e.g., a plurality of clients, a plurality of sensor modules, etc.), but can alternatively manage data for a single system instance.

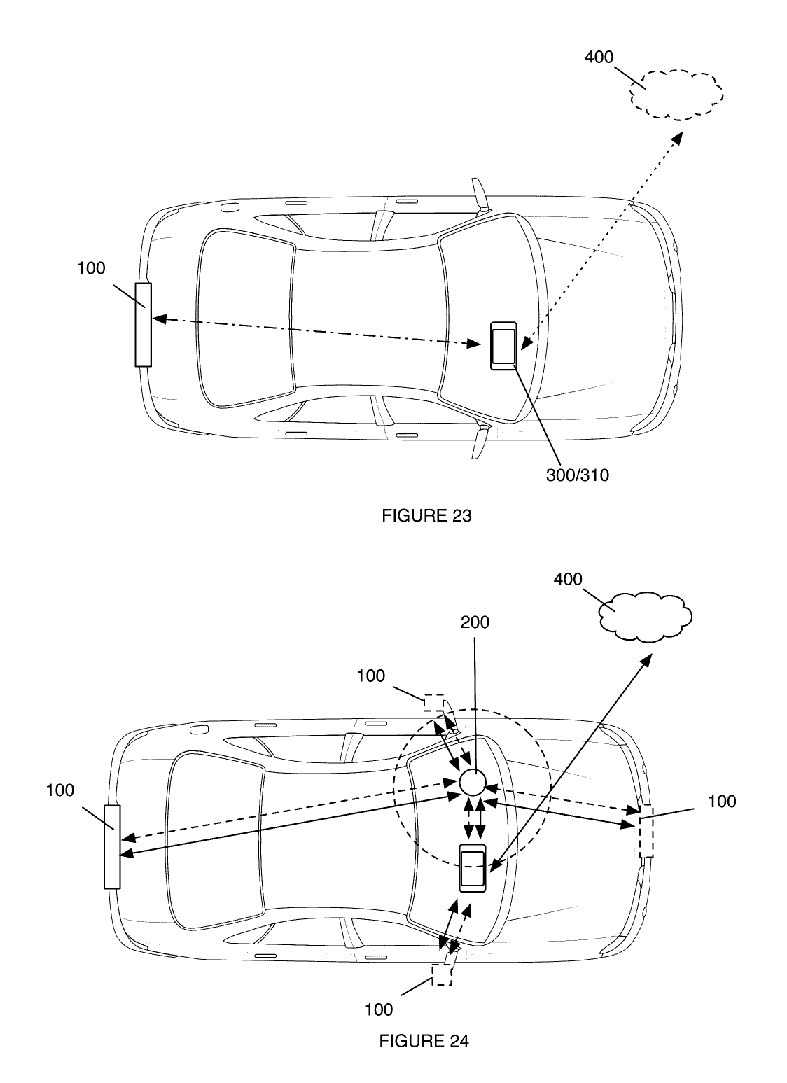

In a first specific example, the system includes a set of sensor modules 100, a hub 200, and a client 300 running on a user device 310, wherein the sensor module acquires sensor measurements, the hub processes the sensor measurements, and the client displays the processed sensor measurements and/or derivatory information to the user, and can optionally communicate information to the remote computing system 400; however, the components can perform any other suitable functionality. In a second specific example (shown in FIG. 22), the system includes a set of sensor modules 100 and a hub 200, wherein the hub can be connected to and control (e.g., wired or wirelessly) a vehicle display, and can optionally communicate information to the remote computing system 400; however, the components can perform any other suitable functionality. In a third specific example (shown in FIG. 23), the system includes a set of sensor modules 100 and the client 300, wherein the client can receive, process, and display the sensor measurements (or derivatory information) from the sensor modules, and optionally communicate information to the remote computing system 400; however, the components can perform any other suitable functionality. In a fourth specific example, the system includes a set of sensor modules 100, wherein the sensor modules can acquire, process, control display of, transmit (e.g., to a remote computing system), or otherwise manage the sensor measurements. However, the system can be otherwise configured.

### 4. Connection Architecture.

As shown in FIG. 5, the sensor module 100, hub 200, and client 300 are preferably selectively connected via one or more communication channels, based on a desired operation mode. The operation mode can be automatically determined based on contextual information, selected by a user (e.g., at the user device), or be otherwise determined. The hub preferably determines the operation mode, and controls the operation modes of the remainder of the system, but the operation mode can alternatively be determined by the user device, remote computing system, sensor module, or by any other suitable system.

The system components can be connected by one or more data connections. The data connections can be wired or wireless. Each data connection can be a high-bandwidth connection, a low-bandwidth connection, or have any other suitable set of properties. In one variation, the system can generate both a high-bandwidth connection and a low-bandwidth connection, wherein sensor measurements are communicated through the high-bandwidth connection, and control signals are communicated through the low-bandwidth connection. Alternatively, the sensor measurements can be communicated through the low-bandwidth connection, and the control signals can be communicated through the high-bandwidth connection. However, the data can be otherwise segregated or assigned to different communication channels.

The low-bandwidth connection is preferably BLE, but can alternatively be Bluetooth, NFC, WiFi (e.g., low-power WiFi), or be any other suitable low-bandwidth and/or low-power connection. The high-bandwidth connection is preferably WiFi, but can alternatively be cellular, Zigbee, Z-Wave, Bluetooth (e.g., long-range Bluetooth), or any other suitable high-bandwidth connection. In one example, a low bandwidth communication channel can have a bit-rate of less than 50 Mbit/s, or have any other suitable bit-rate. In a second example, the high bandwidth communication channel can have a bit-rate of 50 Mbit/s or above, or have any other suitable bit-rate.

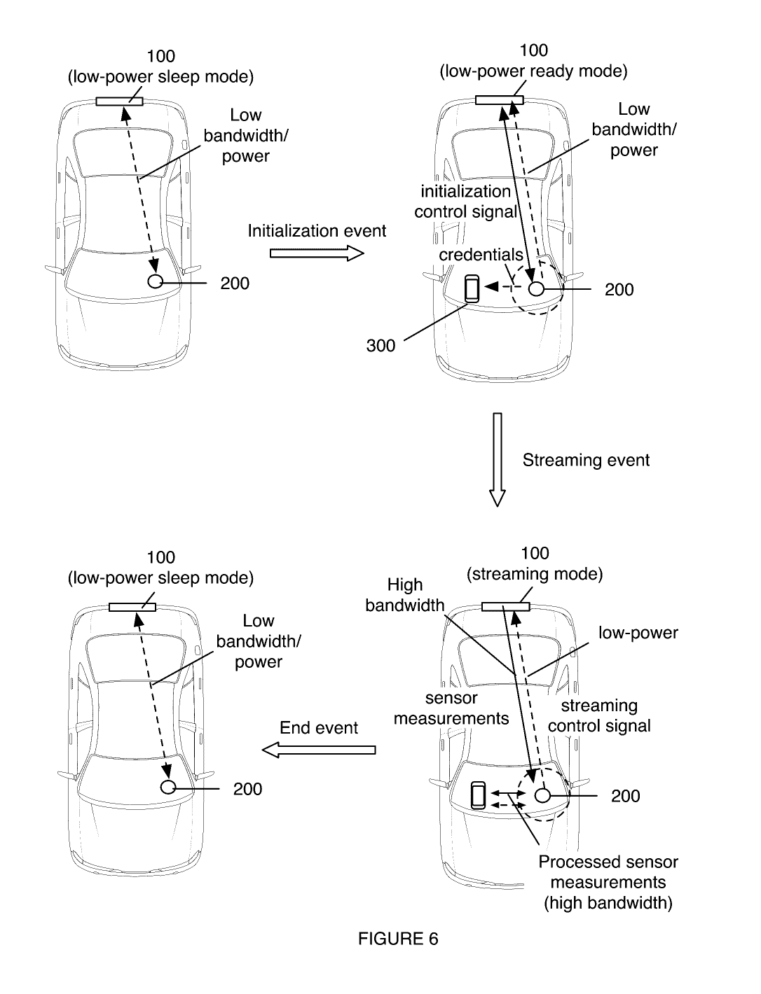

In one variation (example shown in FIG. 6), the method can include: maintaining a low-bandwidth connection between the hub and sensor module; in response to determination of an initiation event, sending a control signal (initialization control signal) from the hub to the sensor module to switch sensor module operation from a low-power sleep mode to a low-power standby mode, and generating a high-bandwidth local network at the hub; connecting the hub to the user device over the high-bandwidth local network; and in response to detection of a streaming event, sending a control signal (streaming control signal) to the sensor module to switch operation modes from the low-power standby mode to the streaming mode, streaming sensor measurements from the sensor module to the hub over the high-bandwidth local network, and streaming processed sensor measurements from the hub to the user device over the high-bandwidth local network. The method can additionally include: in response to determination of an end event (e.g., termination event), disconnecting the sensor module from the high-bandwidth local network while maintaining a low-bandwidth connection to the hub. The high-bandwidth connection between the hub and mobile device can be maintained after sensor module transition to the low-power standby mode, or be disconnected (e.g., wherein the user device can remain connected to the hub through a low-power connection). However, the hub, sensor module, and user device can be otherwise connected.

In this variation, the low-bandwidth connection between the hub and sensor module is preferably maintained across all active operation modes, wherein control instructions, management instructions, state information (e.g., device, environment, usage, etc.), or any other information can be communicated between the hub and sensor module through the low-bandwidth connection. Alternatively, the low-bandwidth connection can be severed when the hub and sensor modules are connected by a high-bandwidth connection, wherein the control instructions, management instructions, state information, or other information can be communicated over the high-bandwidth connection.

The initiation event (initialization event) functions to indicate imminent user utilization of the system. Occurrence of the initiation event can trigger: sensor module operation in the low-power standby mode, local network creation by the hub, application launching by the user device, or initiate any other suitable operation. The initialization event can be a set of secondary sensor measurements, measured by the hub sensors, user device sensors, or any other suitable set of sensors, meeting a predetermined set of sensor measurement values (e.g., the sensor measurements indicating a user entering the vehicle); vehicle activity (e.g., in response to power supply to the hub, vehicle ignition, etc.); user device connection to the hub (e.g., via a low-bandwidth connection or the high-bandwidth connection created by the hub); receipt of a user input (e.g., determination that the user has launched the application, receipt of a user selection of an initiation icon, etc.); identification of a predetermined vehicle action, or be any other suitable initiation event. In one example, the predetermined vehicle action can be a vehicle transmission position (e.g., reverse gear engaged), vehicle lock status (e.g., vehicle unlocked), be any other suitable vehicle action that can be read off the vehicle bus by the hub, or be any other suitable event determined in any suitable manner. The initiation event can alternatively be determined by the hub, but can alternatively be determined by the user device, remote computing system, or other computing system.

The streaming event functions to trigger full system operation. Occurrence of the streaming event can trigger sensor module operation in the streaming mode, sensor module connection to the hub over a high-bandwidth connection, hub operation in the streaming mode, or initiate any other suitable process. The streaming event can be a set of secondary sensor measurements, measured by the hub sensors, user device sensors, or any other suitable set of sensors, meeting a predetermined set of sensor measurement values; when predetermined vehicle operation is identified by the hub (e.g., through data provided through the vehicle connection port); receipt of a user input (e.g., determination that the user has launched the application, receipt of a user selection of an initiation icon, etc.); or be any other suitable streaming event. The streaming event is preferably determined by the hub, but can alternatively be determined by the user device, remote computing system, or other computing system.

For example, the streaming event can be initiated by the vehicle reversing. This can be detected when the vehicle operation data indicates that the vehicle transmission is in the reverse gear; when the orientation sensor (e.g., accelerometer, gyroscope, etc.) of the user device, sensor module, or hub indicates that the vehicle is moving in reverse; or when any other suitable data indicative of vehicle reversal is determined. In a specific example, the sensor module and/or hub can only mount to the vehicle in a single orientation, such that the sensor module or hub can identify vehicle forward and reverse movement. However, the sensor module and/or hub can mount in multiple orientations or be configured to otherwise mount to the vehicle.

The end event functions to indicate when system operation is no longer required. Occurrence of the end event can trigger sensor module operation in the low-power standby mode (e.g., low power ready mode), sensor module disconnection from the high-bandwidth network, or initiate any other process. The end event can be a set of secondary sensor measurements, measured by the hub sensors, user device sensors, or any other suitable set of sensors, meeting a predetermined set of sensor measurement values; when predetermined vehicle operation is identified by the hub (e.g., through data provided through the vehicle connection port, such as engagement of the parking gear or emergency brake); receipt of a user input (e.g., determination that the user has closed the application, receipt of a user selection of an end icon, etc.); determination of an absence of signals received from the hub or user device at the sensor module; or be any other suitable end event. The end event is preferably determined by the hub (e.g., wherein the hub generates a termination control signal in response), but can alternatively be determined by the user device, remote computing system, or other computing system. In a first embodiment, the hub or user device can determine the end event, and send a control signal (e.g., standby control signal, termination control signal) from the hub or user device to the sensor module to switch sensor module operation from the streaming mode to the low-power standby mode, wherein the sensor module switches to the low-power standby mode in response to control signal receipt. In a second embodiment, the hub or user device can send (e.g., broadcast, transmit) backchannel messages (e.g., beacon packets, etc.) while in operation; the sensor module can monitor the receipt of the backchannel messages and automatically operate in the low-power standby mode in response to absence of backchannel message receipt from one or more endpoints (e.g., user device, hub, etc.). In a third embodiment, the sensor module can periodically ping the hub or user device, and automatically operate in the low-power standby mode in response to absence of a response. However, the end event can be otherwise determined.

For example, the end event can be the vehicle driving forward (e.g., vehicle operation in a non-neutral and non-reverse gear; vehicle transition to driving forward, etc.). This can be detected when the vehicle operation data indicates that the vehicle is in a forward gear; when the orientation sensor (e.g., accelerometer, gyroscope, etc.) of the user device, sensor module, or hub indicates that the vehicle is moving forward or is moving in an opposite direction; or when any other suitable data indicative of vehicle driving forward is determined.

The sensor module is preferably operable between the low-power sleep mode, the low-power standby mode, and the streaming mode, but can alternatively be operable between any other suitable set of modes. In the low-power sleep mode, most sensor module operation can be shut off, with a low-power communication channel (e.g., BLE), battery management systems, and battery recharging systems active. In the low-power sleep mode, the sensor module is preferably connected to the hub via the low-power communication channel, but can alternatively be disconnected from the hub (e.g., wherein the sensor module searches for or broadcasts an identifier in the low-power mode), or is otherwise connected to the hub. In a specific example, the sensor module and hub each broadcast beacon packets in the low-power standby mode, wherein the hub connects to the sensor module (or vice versa) based on the received beacon packets in response to receipt of an initialization event.

In the low-power standby mode, most sensor module components can be powered on and remain in standby mode (e.g., be powered, but not actively acquiring or processing). In the low-power standby mode, the sensor module is preferably connected to the hub via the low-power communication channel, but can alternatively be connected via the high-bandwidth communication channel or through any other suitable channel.

In the streaming mode, the sensor module preferably: connects to the hub via the high-bandwidth communication channel, acquires (e.g., records, stores, samples, etc.) sensor measurements, pre-processes the sensor measurements, and streams the sensor measurements to the hub through the high-bandwidth communication channel. In the streaming mode, the sensor module can additionally receive control instructions (e.g., processing instructions, tilt instructions, etc.) or other information from the hub through the high-bandwidth communication channel, low-power communication channel, or tertiary channel. In the streaming mode, the sensor module can additionally send state information, low-bandwidth secondary sensor measurements, or other information to the hub through the high-bandwidth communication channel, low-power communication channel, or tertiary channel. The sensor module can additionally send tuning information (e.g., DTIM interval lengths, duty cycles for beacon pinging and/or check-ins, etc.) to the hub, such that the hub can adjust hub operation (e.g., by adjusting DTIM interval lengths, ping frequencies, utilized communication channels, modulation schemes, etc.) to minimize or reduce power consumption at the sensor module.

The sensor module can transition between operation modes in response to control signal receipt; automatically, in response to a transition event being met; or transition between operation modes at any other suitable time. The control signals sent to the sensor module are preferably determined (e.g., generated, selected, etc.) and sent by the hub, but can alternatively be determined and/or sent by the user device, remote computing system, or other computing system.

The sensor module can transition from the low-power sleep mode to the low-power standby mode in response to receipt of the initialization control signal, and transition from the low-power standby mode to the low-power sleep mode in response to the occurrence of a sleep event. The sleep event can include: inaction for a predetermined period of time (e.g., wherein no control signals have been received for a period of time), receipt of a sleep control signal (e.g., from the hub, in response to vehicle shutoff, etc.), or be any other suitable event.

The sensor module can transition from the low-power standby mode to the streaming mode in response to receipt of the streaming control signal, and transition from the streaming mode to the low-power standby mode in response to receipt of the standby control signal. However, the sensor module can transition between modes in any other suitable manner.

The user device can connect to the hub by: establishing a primary connection with the hub through a low-power communication channel (e.g., the same low-power communication channel as that used by the sensor module or a different low-power communication channel), exchanging credentials (e.g., security keys, pairing keys, etc.) for a first communication channel (e.g., the high-bandwidth communication channel) with the hub over the a second communication channel (e.g., the low-bandwidth communication channel), and connecting to the first communication channel using the credentials. Alternatively, the user device can connect to the hub manually (e.g., wherein the user selects the hub network through a menu), or connect to the hub in any other suitable manner.

The method can additionally include initializing the hub and sensor module, which functions to establish the initial connection between the hub and sensor module. In a first variation, initializing the hub and sensor module includes: pre-pairing the hub and sensor module credentials at the factory; in response to sensor module and/or hub installation, scanning for and connecting to the pre-paired device (e.g., using a low-bandwidth or low-power communication channel). In a second variation, initializing the hub and sensor module includes, at a user device, connecting to the hub through a first communication channel, connecting to the sensor module through a second communication channel, and sending the sensor module credentials to the hub through the first communication channel. Alternatively or additionally, the method can include sending the hub credentials to the sensor module through the second communication channel. The first and second communication channels can be different or the same.

### 5. Sensor Measurement Streaming.

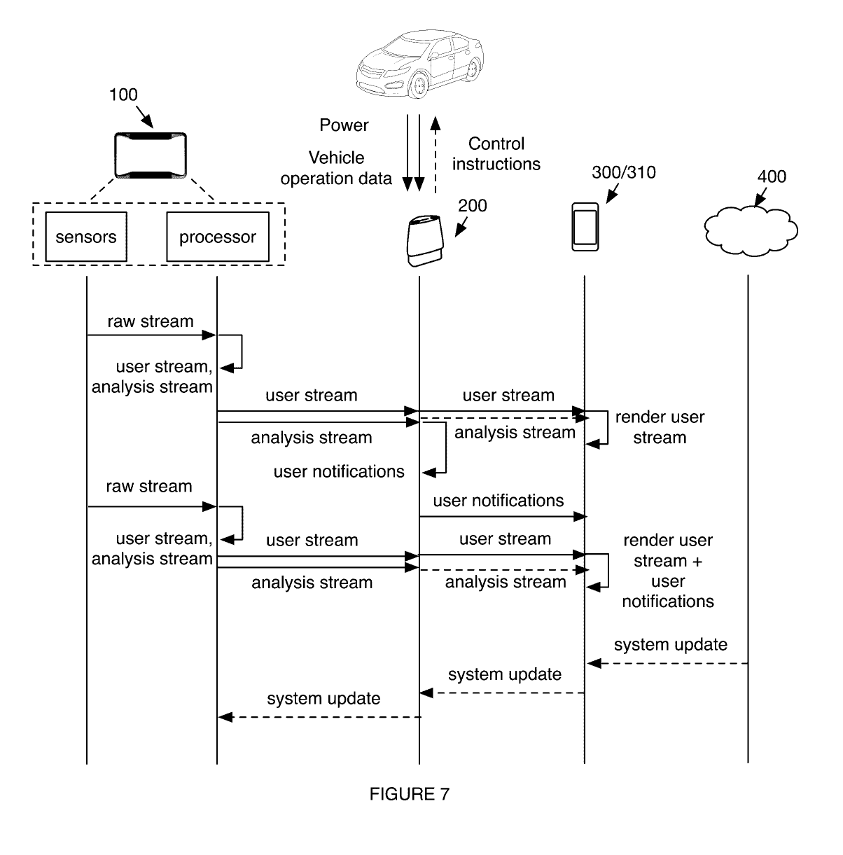

As shown in FIGS. 1 and 7, the method for vehicle sensor management includes: acquiring sensor measurements at a sensor module; transmitting the sensor measurements from the sensor module to a hub connected to the vehicle; processing the sensor measurements; and transmitting the processed sensor measurements from the hub to a user device associated with the system (e.g., with the hub, the vehicle, the sensor module(s), etc.), wherein the processed sensor measurements are rendered on the user device in a user interface. The method functions to provide a user with low latency data about the vehicle environment (e.g., in real- or near-real time). The method can additionally function to automatically analyze the sensor measurements, identify actions or items of interest, and annotate the vehicle environment data to indicate the actions or items of interest on the user view. The method can additionally include: selectively establishing communication channels between the sensor module, hub, and/or user device; responding to user interaction with the user interface; or support any other suitable process.

a. Acquiring Sensor Measurements

Acquiring sensor measurements at a sensor module arranged on a vehicle S100 functions to acquire data indicative of the vehicle surroundings (vehicle environment). Data acquisition can include: sampling the signals output by the sensor, recording the signals, storing the signals, receiving the signals from a secondary endpoint (e.g., through wired or wireless transmission), determining the signals from preliminary signals (e.g., calculating the measurements, etc.), or otherwise acquiring the data. The sensor measurements are preferably acquired by the sensors of the sensor module, but can alternatively or alternatively be acquired by sensors of the hub (e.g., occupancy sensors of the hub), acquired by sensors of the vehicle (e.g., built-in sensors), acquired by sensors of the user device, or acquired by any other suitable system. The sensor measurements are preferably acquired when the system (more preferably the sensor module but alternatively any other suitable component) is operating in the streaming mode, but can alternatively be acquired when the sensor module is operating in the standby mode or another mode. The sensor measurements can be acquired at a predetermined frequency, in response to an acquisition event (e.g., initiation event, receipt of an acquisition instruction from the hub or user device, determination that the field of view has changed, determination that an object within the field of view has changed positions), or be acquired at any suitable time. The sensor measurements can include ambient environment information (e.g., images of the ambient environment proximal, such as behind or in front of, a vehicle or the sensor module), sensor module operation parameters (e.g., module SOC, temperature, ambient light, orientation measurements, etc.), vehicle operation parameters, or any other suitable sensor measurement.

In a specific example, the sensor measurements are video frames acquired by a set of cameras (the sensors). The set of cameras preferably includes two cameras cooperatively forming a stereoscopic camera system having a fixed field of view, but can alternatively include a single camera or multiple cameras. In a first variation, both cameras include wide-angle lenses and produce warped images. In a second variation, a first camera includes a fisheye lens and the second camera includes a normal lens. In a third variation, the first camera is a full-color camera (e.g., measures light across the visible spectrum), and the second camera is a multi-spectral camera (e.g., measures a select subset of light in the visible spectrum). In a fourth variation, the first and second cameras are mounted to the vehicle rear and front, respectively. The camera fields of view preferably cooperatively or individually encompass a spatial region (e.g., physical region, geographic region, etc.) wider than a vehicle width (e.g., more than 2 meters wide, more than 2.5 meters wide, etc.), but can alternatively have any suitable dimension. However, the cameras can include any suitable set of lenses. Both cameras preferably record video frames substantially concurrently (e.g., wherein the cameras are synchronized), but can alternatively acquire the frames asynchronously. Each frame is preferably associated with a timestamp (e.g., the recordation timestamp) or other unique identifier, which can subsequently be used to match and order frames during processing. However, the frames can remain unidentified.

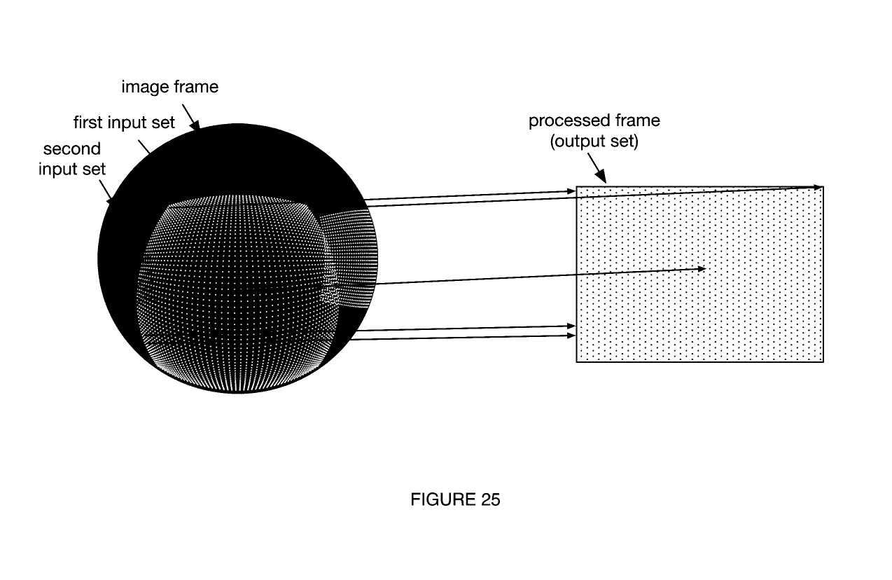

Acquiring sensor measurements at the sensor module can additionally include pre-processing the sensor measurements, which can function to generate the user view (user stream), generate the analysis measurements (e.g., analysis stream), decrease the size of the data to be transmitted, or otherwise transform the data. This is preferably performed by dedicated hardware, but can alternatively be performed by software algorithms executed by the sensor module processor. The pre-processed sensor measurements can be a single stream (e.g., one of a pair of videos recorded by a stereo camera, camera pair, etc.), a composited stream, multiple streams, or any other suitable stream. Pre-processing the sensor measurements can include: compressing the sensor measurements, encrypting the sensor measurements, selecting a subset of the sensor measurements, filtering the sensor measurements (e.g., to accommodate for ambient light, image washout, low light conditions, etc.), or otherwise processing the sensor measurements. In a specific example (shown in FIG. 25), processing the set of input pixels can include mapping each input pixel (e.g., of an input set) to an output pixel (e.g., of an output set) based on a map, and interpolating the pixels between the resultant output pixels to generate an output frame. The input pixels can optionally be transformed (e.g., filtered, etc.) before or after mapping to the output pixel. The map can be determined based on processing instructions (e.g., predetermined, dynamically determined), or otherwise determined. When the sensor measurements include images (e.g., video frames), pre-processing the sensor measurements can optionally include de-warping warped images. However, pre-processing the sensor measurements can include performing any other of the aforementioned algorithms on the sensor measurements with the sensor module.

Pre-processing the sensor measurements can additionally include adjusting a size of the video frames. This can function to resize the video frame for the user device display, while maintaining the right zoom level for the user view. This can additionally function to digitally “move” the camera field of view, which can be particularly useful when the camera is static. This can also function to decrease the file size of the measurements. One or more processes can be applied to the sensor measurements concurrently, serially, or in any other suitable order. The sensor measurements are preferably processed according to processing instructions (user stream instructions), wherein the processing instructions can be predetermined and stored by the system (e.g., the sensor module, hub, client, etc.); received from the hub (e.g., wherein the hub can generate the processing instructions from a user input, such as a pan/tilt/zoom selection, etc.); received from the user device; include sub-instructions received from one or more endpoints; or be otherwise determined.

In a first variation, adjusting the size of the video frames can include processing a set of input pixels from each video frame based on the processing instructions. This can function to concurrently or serially apply one or more processing techniques (e.g., dewarping, sampling, cropping, mosaicking, compositing, etc.) to the image, and output an output frame matching a set of predetermined parameters. The processing instructions can include the parameters of a transfer function (e.g., wherein the input pixels are processed with the transfer function), input pixel identifiers, or include any other suitable set of instructions. The input pixels can be specified by pixel identifier (e.g., coordinates), by a sampling rate (e.g., every 6 pixels), by an alignment pixel and output frame dimensions, or otherwise specified. The set of input pixels can be a subset of the video frame (e.g., less than the entirety of the frame), the entirety of the frame, or any other suitable portion of the frame. The subset of the video frame can be a segment of the frame (e.g., wherein the input pixels within the subset are contiguous), a sampling of the frame (e.g., wherein the input pixels within the subset are separated by one or more intervening pixels), or be otherwise related.

In a second variation, adjusting the size of the video frames can include cropping the de-warped video frames, wherein the processing instructions include cropping instructions. The cropping instructions can include: cropping dimensions (e.g., defining the size of a retained section of the video frame, indicative of frame regions to be cropped out, etc.; can be determined based on the user device orientation, user device type, be user selected, or otherwise determined) and a set of alignment pixel coordinates (e.g., orientation pixel coordinates, etc.), a set of pixel identifiers bounding the image portion to be retained or cropped or cropped out, or any other suitable information indicative of the video frame section to be retained. The set of alignment pixel coordinates can be a center alignment pixel set (e.g., wherein the center of the retained region is aligned with the alignment pixel coordinates), a corner alignment pixel set (e.g., wherein a predetermined corner of the retained region is aligned with the alignment pixel coordinates), or function as a reference point for any other suitable portion of the retained region. The video frames can be cropped by the sensor module, the hub, the user device, or by any other suitable system. The cropping instructions can be default cropping instructions, automatically determined cropping instructions (e.g., learned preferences for a user account or vehicle), cropping instructions generated based on a user input, or be otherwise determined.

Alternatively or additionally, the video frames can be pre-processed based on the user input, wherein the sensor module receives the user stream input and determines the pixels to retain and/or remove from the user stream. The user stream input is preferably received from the hub, wherein the hub received the input from the user device, which, in turn, received the input from the user or the remote server system, but can alternatively be received directly from the user device, received from the remote server system, or be received from any other source. Pre-processing the sensor measurements can additionally include compressing the video streams (e.g., the first, second, and/or user streams). However, the video streams can be otherwise processed.

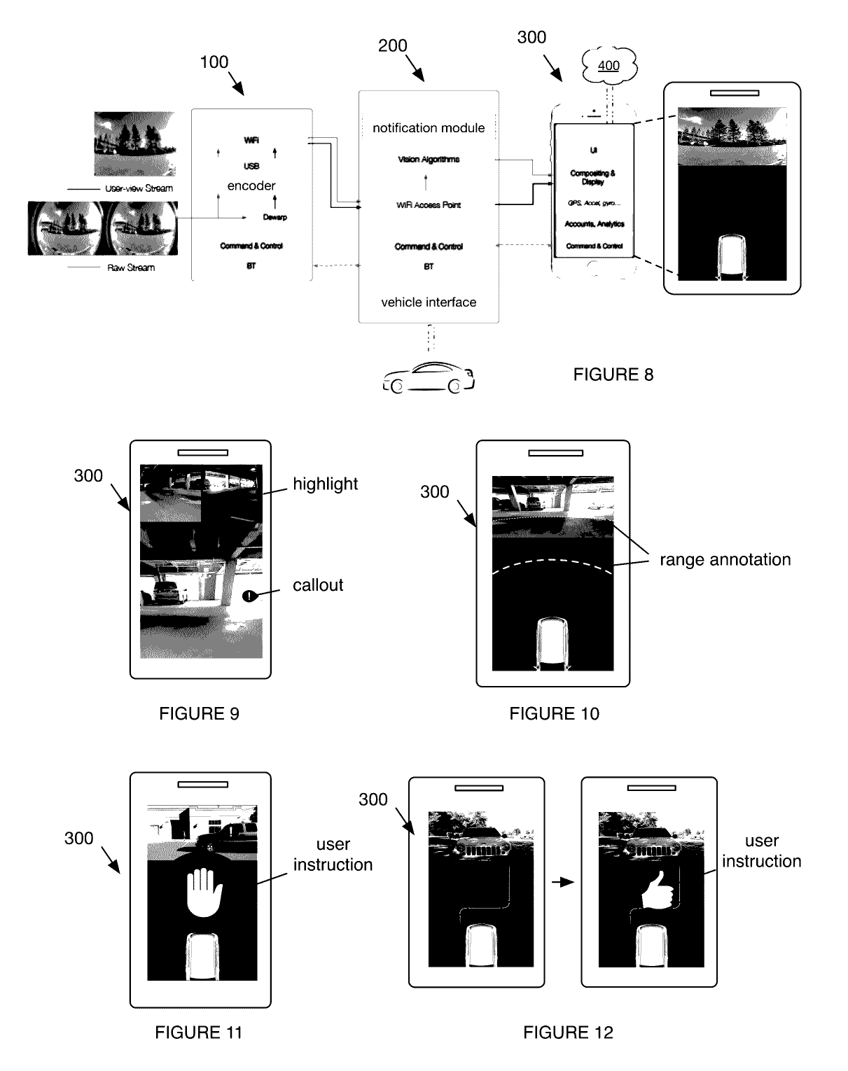

In the specific example above, pre-processing the sensor measurements can include de-warping the frames of one of the video streams (e.g., the video stream from the first camera) to create the user stream, and leaving the second video stream unprocessed, example shown in FIG. 8. The field of view of the first and second video streams can be different (e.g., separate and distinct, overlap, acquired from different sensors, etc.), or the same (e.g., recorded by the same sensor, be the same video stream, coincide, etc.). Alternatively, pre-processing the sensor measurements can include de-warping the frames of both video streams and merging substantially concurrent frames (e.g., frames recorded within a threshold time of each other) together into a user stream. However, the sensor measurements can be otherwise pre-processed.

b. Transmitting Sensor Measurements

Transmitting the sensor measurements from the sensor module S200 functions to transmit the sensor measurements to the receiving system (processing center, processing system of the system, e.g., hub, user device, etc.) for further processing and analysis. The sensor measurements are preferably transmitted to the hub, but can alternatively or additionally be transmitted to the user device (e.g., wherein the user device processes the sensor measurements), to the remote computing system, or to any other computing system. The sensor measurements are preferably transmitted over a high-bandwidth communication channel (e.g., WiFi), but can alternatively be transmitted over a low-bandwidth communication channel or be transmitted through any other suitable communication means. The communication channel is preferably established by the hub, but can alternatively be established by the sensor module, by the user device, by the vehicle, or by any other suitable component. In a specific example, the hub creates and manages a WiFi network (e.g., functions as a router or hotspot), wherein the sensor module selectively connects to the WiFi network in the streaming mode and sends sensor measurements over the WiFi network to the hub. The sensor measurements can be transmitted in near-real time (e.g., as they are acquired), at a predetermined frequency, in response to a transmission request from the hub, or at any other suitable time.

The transmitted sensor measurements are preferably analysis measurements, (e.g., wherein a time-series of analysis measurements form an analysis stream), but can alternatively be any other suitable set of measurements. The analysis measurements can be pre-processed measurements (e.g., dewarped, sampled, cropped, mosaicked, composited, etc.), raw measurements (e.g., raw stream, unprocessed measurements, etc.), or be otherwise processed.

In the specific example above, transmitting the analysis measurements can include: concurrently transmitting both video streams and the user stream to the hub over the high-bandwidth connection. Alternatively, transmitting the sensor measurements can include: transmitting the user stream and the second video stream (e.g., the stream not used to create the user stream).

Alternatively, transmitting the analysis measurements can include: concurrently transmitting both video streams to the hub, and asynchronously transmitting the user stream after pre-processing. In this variation, the method can additionally include transmitting frame synchronization information to the hub, wherein the frame synchronization information can be the acquisition timestamp of the raw video frame (e.g., underlying video frame) or other frame identifier. The frame synchronization information can be sent through the high-bandwidth communication connection, through a second, low-bandwidth communication connection, or through any other suitable communication channel.

Alternatively, transmitting the sensor measurements can include transmitting only the user stream(s) to the hub. However, any suitable raw or pre-processed video stream can be sent to the hub at any suitable time.

c. Processing the Sensor Measurements.

Processing the sensor measurements S300 functions to identify sensor measurement features of interest to the user. Processing the sensor measurements can additionally function to generate user view instructions (e.g., for the sensor module). For example, cropping or zoom instructions can be generated based on sensor module distance to an obstacle (e.g., generate instructions to automatically zoom-in the user view to artificially make the obstacle seem closer than it actually is).

The sensor measurements can be entirely or partially processed by the hub, the sensor module, the user device, the remote computing system, or any other suitable computing system. The sensor measurements can be processed into (e.g., transformed into) user notifications, vehicle instructions, user instructions, or any other suitable output. The sensor measurements being processed can include: the user stream, analysis sensor measurements (e.g., pre-processed, such as dewarped, or unprocessed), or sensor measurements having any other suitable processed state. In processing the sensor measurements, the method can use: sensor measurements of the same type (e.g., acquired by the same or similar sensors), sensor measurements of differing types (e.g., acquired by different sensors), vehicle data (e.g., read off the vehicle bus by the hub), sensor module operation data (e.g., provided by the sensor module), user device data (e.g., as acquired and provided by the user device), or use any other suitable data. When the data is obtained by a system external or remote to the system processing the sensor measurements, the data can be sent by the acquiring system to the processing system.

Processing the sensor measurements can include: generating the user stream (e.g., by de-warping and cropping raw video or frames to the user view), fusing multiple sensor measurements (e.g., stitching a first and second video frame having overlapping or adjacent fields of view together, etc.), generating stereoscopic images from a first and second concurrent video frame captured by a first and second camera of known relative position, overlaying concurrent video frames captured by a first and second camera sensitive to different wavelengths of light (e.g., a multispectral image and a full-color image), processing the sensor measurements to accommodate for ambient environment parameters (e.g., selectively filtering the image to prevent washout from excessive light), processing the sensor measurements to accommodate for vehicle operation parameters (e.g., to retain portions of the video frame proximal the left side of the vehicle when the left turn signal is on), or otherwise generating higher-level sensor data. Processing the sensor measurements can additionally include extracting information from the sensor measurements or higher-level sensor data, such as: detecting objects from the sensor measurements, detecting object motion (e.g., between frames acquired by the same or different cameras, based on acoustic patterns, etc.), interpreting sensor measurements based on secondary sensor measurements (e.g., ignoring falling leaves and rain during a storm), accounting for vehicle motion (e.g., stabilizing an image, such as accounting for jutter or vibration, based on sensor module accelerometer measurements, etc.), or otherwise processing the sensor measurements.

In one variation, processing the sensor measurements can include identifying sensor measurement features of interest from the sensor measurements and modifying the displayed content based on the sensor measurement features of interest. However, the sensor measurements can be otherwise processed.

The sensor measurement features of interest are preferably indicative of a parameter of the vehicle's ambient environment, but can alternatively be indicative of sensor module operation or any other suitable parameter. The ambient environment parameter can include: object presence proximal the vehicle (e.g., proximal the sensor module), object location or position relative to the vehicle (e.g., object position within the video frame), object distance from the vehicle (e.g., distance from the sensor module, as determined from one or more stereoimages), ambient light, or any other suitable parameter.

Identifying sensor measurement features of interest can include extracting features from the sensor measurements, identifying objects within the sensor measurements (e.g., within images; classifying objects within the images, etc.), recognizing patterns within the sensor measurements, or otherwise identifying sensor measurement features of interest. Examples of features that can be extracted include: signal maxima or minima; lines, edges, and ridges; gradients; patterns; localized interest points; object position (e.g., depth, such as from a depth map generated from a set of stereoimages); object velocity (e.g., using motion analysis techniques, such as egomotion, tracking, optical flow, etc.); or any other suitable feature.

In a first embodiment, identifying sensor features of interest includes identifying objects within the video frames (e.g., images). The video frames are preferably post-processed video frames (e.g., dewarped, mosaicked, composited, etc.; analysis video frames), but can alternatively be raw video frames (e.g., unprocessed) or otherwise processed. Identifying the objects can include: processing the image to identify regions indicative of an object, and identifying the object based on the identified regions. The regions indicative of an object can be extracted from the image using any suitable image processing technique. Examples of image processing techniques include: background/foreground segmentation, feature detection (e.g., edge detection, corner/interest point detection, blob detection, ridge detection, vectorization, etc.), or any other suitable image processing technique.

The object can be recognized using object classification algorithms, detection algorithms, shape recognition, identified by the user, identified based on sound (e.g., using stereo-microphones), or otherwise recognized. The object can be recognized using appearance-based methods (e.g., edge matching, divide-and-conquer search, greyscale matching, gradient matching, large modelbases, histograms, etc.), feature-based methods (e.g., interpretation trees, pose consistency, pose clustering, invariance, geometric hashing, SIFT, SURF, etc.), genetic algorithms, or any other suitable method. The recognized object can be stored by the system or otherwise retained. However, the sensor measurements can be otherwise processed.

In an example of object classification, the method can include training an object classification algorithm using a set of known, pre-classified objects and classifying objects within a single or composited video frame using the trained object classification algorithm. In this example of object classification, the method can additionally include segmenting the foreground from the background of the video frame, and identifying objects in the foreground only. Alternatively, the entire video frame can be analyzed. However, the objects can be classified in any other suitable manner. However, any other suitable machine learning technique can be used.

In an example of object detection, the method includes scanning the single or composited video frame or image for new objects. For example, a recent video frame of the user's driveway can be compared to a historic image of the user's driveway, wherein any objects within the new video frame but missing from the historic image can be identified. In this example, the method can include: determining the spatial region associated with the sensor's field of view, identifying a reference image associated with the spatial region, and detecting differences between the first frame (frame being analyzed) and the reference image. An identifier for the spatial region can be determined (e.g., measured, calculated, etc.) using a location sensor (e.g., GPS system, trilateration system, triangulation system, etc.) of the user device, hub, sensor module, or any other suitable system, be determined based on an external network connected to the system, or be otherwise determined. The spatial region identifier can be a venue identifier, geographic identifier, or any other suitable identifier. The reference image can additionally be retrieved based on an orientation of the vehicle, as determined from an orientation sensor (e.g., compass, accelerometer, etc.) of the user device, hub, sensor module, or any other suitable system mounted in a predetermined position relative to the vehicle. For example, the reference driveway image can be selected for videos acquired by a rear sensor module (e.g., backup camera) in response to the vehicle facing toward the house, while the same reference driveway image can be selected for videos acquired by a front sensor module in response to the vehicle facing away from the house. In some variations, the spatial region identifier is for the geographic location of the user device or hub (which can differ from the field of view's geographic location) and can be the spatial region identifier can be associated with, and/or used to retrieve, the reference image. Alternatively, the geographic region identifier can be for the field of view's geographic location, or be any other suitable geographic region identifier.

The reference image is preferably of the substantially same spatial region as that of the sensor field of view (e.g., overlap with or be coincident with the spatial region), but can alternatively be different. The reference image can be a prior frame taken within a threshold time duration of the first frame, be compared to a prior frame taken more than a threshold time duration of the first frame, be compared to an average image generated from multiple historical images (e.g., field of view), be compared to a user-selected image (e.g., field of view), or be compared to any other suitable reference image. The reference image (e.g., image of the driveway and street) is preferably associated with a spatial region identifier, wherein the associated spatial region identifier can be the identifier (e.g., geographic coordinates) for the field of view or a different spatial region (e.g., the location of the sensor module acquiring the field of view, the location of the vehicle supporting the sensor module, etc.). Alternatively, the presence of an object can be identified in a first video stream (e.g., a grayscale video stream), and be classified using the second video stream (e.g., a color video stream). However, objects can be identified in any other suitable manner.

In a second embodiment, identifying sensor features of interest includes determining object motion (e.g., objects that change position between a first and second consecutive video frame). Object motion can be identified by tracking objects across sequential frames, determining optical flow between frames, or otherwise determining motion of an object within the field of view. The analyzed frames can be acquired by the same camera, by different cameras, be a set of composite images (e.g., a mosaicked image or stereoscopic image), or be any other suitable set of frames. In one variation, the detecting object motion can include: identifying objects within the frames, comparing the object position between frames, and identifying object motion if the object changes position between a first and second frame. The method can additionally include accounting for vehicle motion, wherein an expected object position in the second frame can be determined based on the motion of the vehicle. The vehicle motion can be determined from: the vehicle odometer, the vehicle wheel position, a change in system location (e.g., determined using a location sensor of a system component), or be otherwise determined. Object motion can additionally or alternatively be determined based on sensor data from multiple sensor types. For example, sequential audio measurements from a set of microphones (e.g., stereo microphones) can be used to augment or otherwise determine object motion relative to the vehicle (e.g., sensor module). Alternatively, object motion can be otherwise determined. However, the sensor measurement features can be changes in temperature, changes in pressure, changes in ambient light, differences between an emitted and received signal, or be any other suitable sensor measurement feature.

Modifying the displayed content can include: generating and presenting user notifications based on the sensor measurement features of interest; removing identified objects from the video frame; or otherwise modifying the displayed content.

Generating user notifications based on the sensor measurement features of interest functions to call user attention to the identified feature of interest, and can additionally function to recommend or control user action. The user notifications can be associated with graphics, such as callouts (e.g., indicating object presence in the vehicle path or imminent object presence, examples shown in FIGS. 9 and 11), highlights (e.g., boxes around an errant object, example shown in FIG. 9), warning graphics, text boxes (e.g., “Child,” “Toy”), or any other suitable graphic, but can alternatively be associated with user instructions (e.g., “Stop!”), range instructions (example shown in FIG. 10), vehicle instructions (e.g., instructions to apply the brakes, wherein the hub can be a two-way communication connection, example shown in FIGS. 11 and 12), sensor module instructions (e.g., to change the zoom, tilt, or pan of the user stream, to actuate the sensor, etc.), or include any other suitable user notification. The user notification can be composited with the user stream or user view (e.g., by the client; overlaid on the user stream; etc), presented by the hub (e.g., played by a hub speaker), presented by the user stream (e.g., played by a user device speaker), or otherwise presented.

The user notification can include the graphic itself, an identifier for the graphic (e.g., wherein the user device displays the graphic identified by the graphic identifier), the user instructions, an identifier for the user instructions, the sensor module instructions, an identifier for the sensor module instructions, or include any other suitable information. The user notification can optionally include instructions for graphic or notification display. Instructions can include the display time, display size, display location (e.g., relative to the display region of the user device, relative to a video frame of the user stream, relative to a video frame of the composited stream, etc.), parameter value (e.g., vehicle-to-object distance, number of depth lines to display, etc.) or any other suitable display information. Examples of the display location include: pixel centering coordinates for the graphic, display region segment (e.g., right side, left side, display region center), or any other suitable instruction. The user notification is preferably generated based on parameters of the identified object, but can be otherwise generated. For example, the display location can be determined (e.g., match) based on the object location relative to the vehicle; the highlight or callout can have the same profile as the object; or any other suitable notification parameter can be determined based on an object parameter. The user notification can be generated from the user stream, raw source measurements used to generate the user stream, raw measurements not used to generate the user stream (e.g., acquired synchronously or asynchronously), analysis measurements, or generated from any other suitable set of measurements.

In a first example of processing the sensor measurements, the sensor measurement features of interest are objects of interest within a video frame (e.g., car, child, animal, toy, etc.), wherein the method automatically highlights the object within the video frame, emits a sound (e.g., through the hub or user device), or otherwise notifies the user.

Removing identified objects from the video frame functions to remove recurrent objects from the video frame. This can function to focus the user on the changing ambient environment (e.g., instead of the recurrent object). This can additionally function to virtually unobstruct the camera line of sight previously blocked by the object. However, removing objects from the video frame can perform any other suitable functionality. Static objects can include: bicycle racks, trailers, bumpers, or any other suitable object. The objects can be removed by the sensor module (e.g., during pre-processing), the hub, the user device, the remote computing system, or by any other suitable system. The objects are preferably removed from the user stream, but can alternatively or additionally be removed from the raw sensor measurements, the processed sensor measurements, or from any other suitable set of sensor measurements. The objects are preferably removed prior to display, but can alternatively be removed at any other suitable time.

Removing identified objects from the video frame can include: identifying a static object relative to the sensor module and digitally removing the static object from one or more video frames.

Identifying a static object relative to the sensor module functions to identify an object to be removed from subsequent frames. In a first variation, identifying a static object relative to the sensor module can include: automatically identifying a static object from a plurality of video frames, wherein the object does not move within the video frame, even though the ambient environment changes. In a second variation, identifying a static object relative to the sensor module can include: identifying an object within the video frame and receiving a user input indicating that the object is a static object (e.g., receiving a static object identifier associated with a known static object, receiving a static obstruction confirmation, etc.). In a third variation, identifying a static object relative to the sensor module can include: identifying the object within the video frame and classifying the object as one of a predetermined set of static objects. However, the static object can be otherwise identified.

Digitally removing the static object functions to remove the visual obstruction from the video frame. In a first variation, digitally removing the static object includes: segmenting the video frame into a foreground and background, and retaining the background. In a second variation, digitally removing the static object includes: treating the region of the video frame occupied by the static object as a lost or corrupted part of the frame, and using image interpolation or video interpolation to reconstruct the obstructed portion of the background (e.g., using structural inpainting, textural inpainting, etc.). In a third variation, digitally removing the static object includes: identifying the pixels displaying the static object and removing the pixels from the video frame.

Removing the object from the video frame can additionally include filling the region left by the removed object (e.g., blank region). The blank region can be filled with a corresponding region from a second camera's video frames (e.g., region corresponding to the region obstructed by the static object in the first camera's field of view), remain unfilled, be filled in based on pixels adjacent the blank space (e.g., wherein the background is interpolated), be filled in using an image associated with the spatial region or secondary object detected in the background, or otherwise filled in.

Removing the object from the video frame can additionally include storing the static object identifier associated with the static object, pixels associated with the static object, or any other suitable information associated with the static object (e.g., to enable rapid processing of subsequent video frames). The static object information can be stored by the sensor module, the hub, the user device, the remote computing system, or by any other suitable system.

In a specific example, the method includes identifying the static object at the hub (e.g., based on successive video frames, wherein the object does not move relative to the camera field of view), identifying the frame parameters associated with the static object (e.g., the pixels associated with the static object) at the hub, and transmitting the frame parameters to the sensor module, wherein the sensor module automatically removes the static object from subsequent video frames based on the frame parameters. In the interim (e.g., before the sensor module begins removing the static object from the video frames), the hub can leave the static object in the frames, remove the static object from the frames, or otherwise process the frames.

In a specific example, processing the sensor measurements can include: compositing a first and second concurrent frame (acquired substantially concurrently by a first and second camera, respectively) into a composited image; identifying an object in the composited image; and generating a user notification based on the identified object. The composited image can be a stereoscopic image, a mosaicked image, or any other suitable image. A series of composited images can form a composited video stream. In one example, an object about to move into the user view (e.g., outside of the user view of the user stream, but within the field of view of the cameras) is detected from the composited image, and a callout can be generated based on the moving object. The callout can be instructed to point to the object (e.g., instructed to be rendered on the side of the user view proximal the object). However, any other suitable notification can be generated.

However, the sensor measurements can be processed in any other suitable manner.

d. Transmitting Processed Sensor Measurements to the Client for Display.

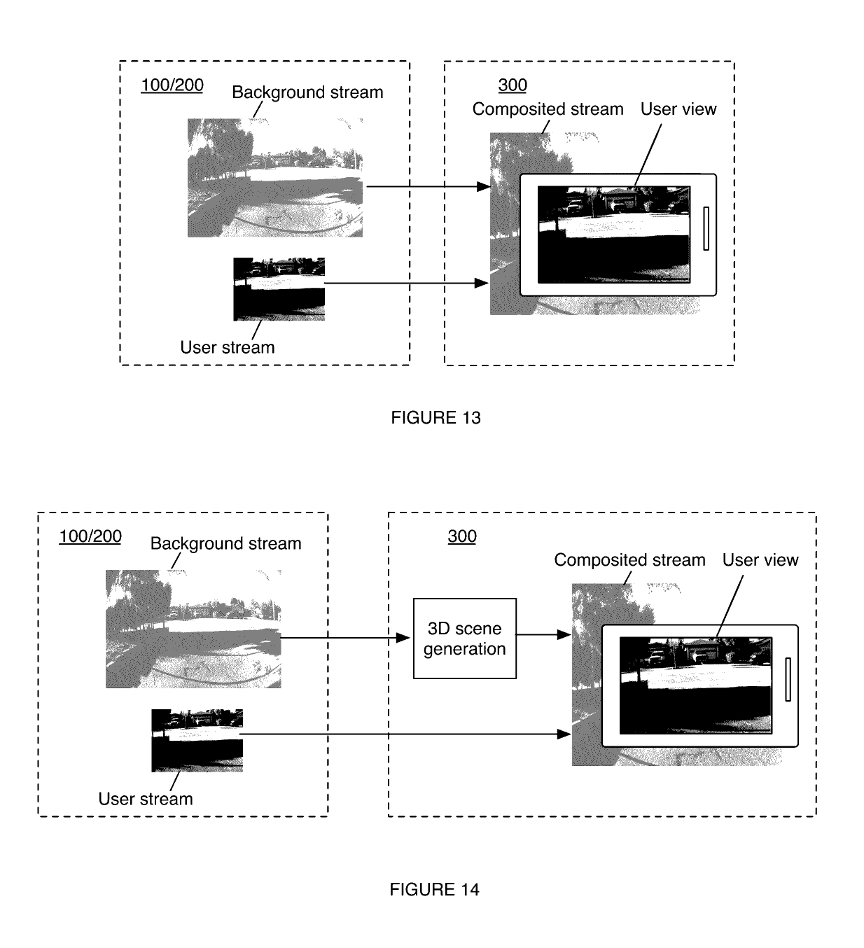

Transmitting the processed sensor measurements to the client associated with the vehicle, hub, and/or sensor module S400 functions to provide the processed sensor measurements to a display for subsequent rendering. The processed sensor measurements can be sent by the hub, the sensor module, a second user device, the remote computing system, or other computing system, and be received by the sensor module, vehicle, remote computing system, or communicated to any suitable endpoint. The processed sensor measurements preferably include the output generated by the hub (e.g., user notifications), and can additionally or alternatively include the user stream (e.g., generated by the hub or the sensor module), a background stream substantially synchronized and/or aligned with the user stream (example shown in FIG. 13), a composite stream, and/or any suitable video stream.

The processed sensor measurements are preferably transmitted over a high-bandwidth communication channel (e.g., WiFi), but can alternatively be transmitted over a low-bandwidth communication channel or be transmitted through any other suitable communication means. The processed sensor measurements can be transmitted over the same communication channel as analysis sensor measurement transmission, but can alternatively be transmitted over a different communication channel. The communication channel is preferably established by the hub, but can alternatively be established by the sensor module, by the user device, by the vehicle, or by any other suitable component. In the specific example above, the sensor module selectively connects to the WiFi network created by the hub, wherein the hub sends processed sensor measurements (e.g., the user notifications, user stream, a background stream) over the WiFi network to the hub. The processed sensor measurements can be transmitted in near-real time (e.g., as they are generated), at a predetermined frequency, in response to a transmission request from the user device, or at any other suitable time.

The user device associated with the vehicle can be a user device located within the vehicle, but can alternatively be a user device external the vehicle. The user device is preferably associated with the vehicle through a user identifier (e.g., user device identifier, user account, etc.), wherein the user identifier is stored in association with the system (e.g., stored in association with a system identifier, such as a hub identifier, sensor module identifier, or vehicle identifier by the remote computing system; stored by the hub or sensor module, etc.). Alternatively, the user device stores and is associated with a system identifier. User device location within the vehicle can be determined by: comparing the location of the user device and the vehicle (e.g., based on the respective location sensors), determining user device connection to the local vehicle network (e.g., generated by the vehicle, or hub), or otherwise determined. In one example, the user device is considered to be located within the vehicle when the user device is connected to the system (e.g., vehicle, hub, sensor module) by a short-range communication protocol (e.g., NFC, BLE, Bluetooth). In a second example, the user device is considered to be located within the vehicle when the user device is connected to the high-bandwidth communication channel used to transmit analysis and/or user sensor measurements. However, the user device location can be otherwise determined.

The method can additionally include accommodating for multiple user devices within the vehicle. In a first variation, the processed sensor measurements can be sent to all user devices within the vehicle that are associated with the system (e.g., have the application installed, are associated with the hub or sensor module, etc.). In a second variation, the processed sensor measurements can be sent to a subset of the user devices within the vehicle, such as only to the driver device or only to the passenger device. The identity of the user devices (e.g., driver or passenger) can be determined based on the spatial location of the user devices (e.g., the GPS coordinates), the orientation of the user device (e.g., an upright user device can be considered a driver user device or phone), the amount of user device motion (e.g., a still user device can be considered a driver user device), the amount, type, or other metric of data flowing through or being displayed on the user device (e.g., a user device with a texting client open and active can be considered a passenger user device), the user device actively executing the client, or otherwise determined. In a third variation, the processed sensor measurements are sent to the user device is connected to a vehicle mount, wherein the vehicle mount can communicate a user device identifier or user identifier to the hub or sensor module, or otherwise identify the user device. However, multiple user devices can be otherwise accommodated by the system.

In response to processed sensor measurement receipt, the client can render the processed sensor measurement on the display (e.g., in a user interface) of the user device S500. In a first variation, the processed sensor measurements can include the user stream and the user notification. The user stream and user notifications can be rendered asynchronously (e.g., wherein concurrently rendered user notifications and the user streams are generated from the different raw video frames, taken at different times), but can alternatively be rendered concurrently (e.g., wherein concurrently rendered user notifications and the user streams are generated from the same raw video frames), or be otherwise temporally related. In one variation, the user device receives a user stream and user notifications from the hub, wherein the user device composites the user stream and the user notifications into a user interface, and renders the user interface on the display.

In a second variation, the processed sensor measurements can include the user stream, the user notification, and a background stream (example shown in FIG. 7). The user stream and background stream are preferably rendered in sync (e.g., wherein a user stream frame is generated from the concurrently rendered background stream frame), while the user notifications can be asynchronous (e.g., delayed). The user stream and user notifications are preferably rendered on the user device display (e.g., in and/or by the application), while the background stream is not rendered by default. However, the background stream can be rendered, and the multiple streams can have any suitable temporal relationship.

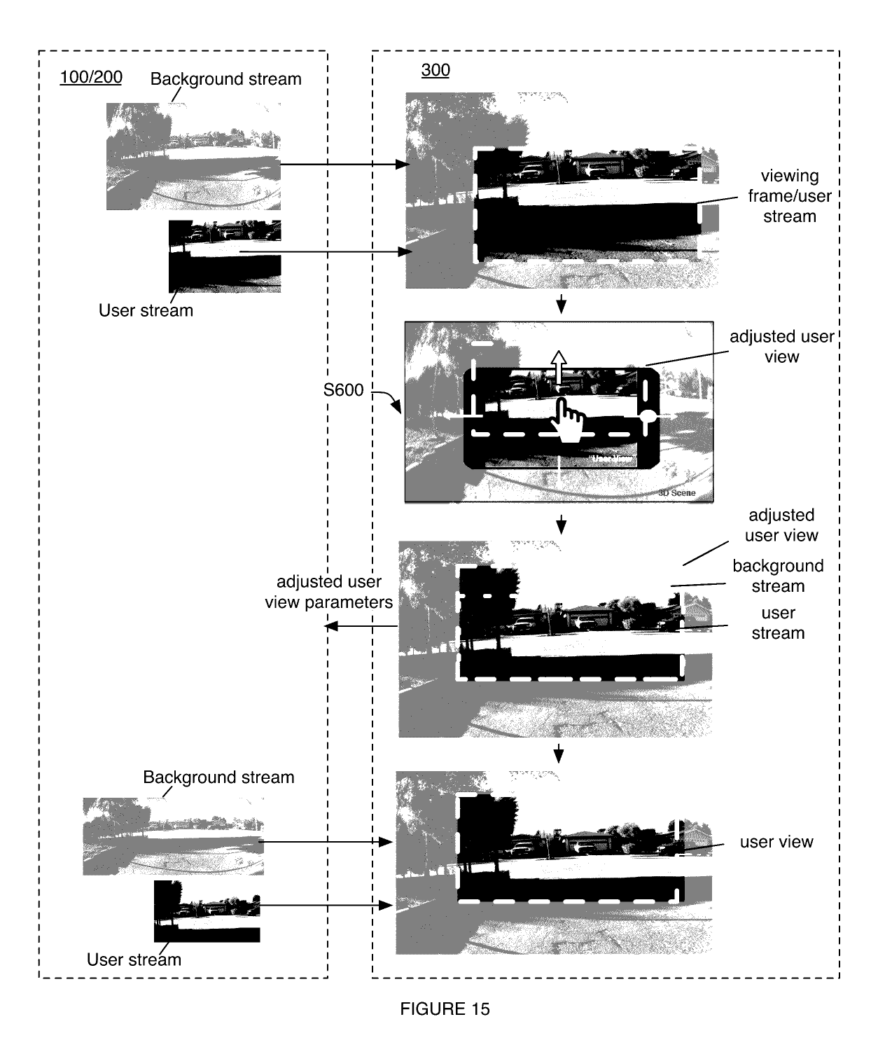

The background stream functions to fill in empty areas when the user adjusts the frame of view on the user interface (e.g., when the user moves the field of view to a region outside the virtual region shown by the user stream, example shown in FIG. 15), but can alternatively be otherwise used. The background stream preferably encompasses or represents a larger spatial region (e.g., shows a larger area) than the user stream and/or covers spatial regions outside of that covered by the user stream field of view (e.g., include all or a portion of the analysis video cropped out of the user stream). However, the background stream can be smaller than the user stream or encompass any other suitable spatial region. The background stream can be a processed stream or raw stream. The background stream can be the video stream from which the user stream was generated, be a processed stream generated from the same video stream as the user stream, be a different video stream (e.g., a video stream from a second camera, a composited video stream, etc.), or be any suitable video stream. The background stream can be concurrently acquired with the source stream from which the user stream was generated, acquired within a predetermined time duration of user stream acquisition (e.g., within 5 seconds, 5 milliseconds, etc), asynchronously acquired, or otherwise temporally related to the user stream. In one variation, when background stream is a composite, different portions of the background stream are provided by different video streams (e.g., the top of the frame is provided by a first stream and the bottom of the frame is provided by a second stream). However, the background stream can be otherwise generated. The background stream can have the same amount, type, or degree of distortion as the user stream or different distortion from the user stream. In one example, the background stream can be a warped image (e.g., a raw frame acquired with a wide-angle lens), while the user stream can be a flattened or de-warped image. The background stream can have the same resolution, less resolution, or higher resolution than the user stream. The background stream can have any other suitable set of parameters.

In the specific example above, transmitting the processed sensor measurements can include: transmitting the user stream (e.g., as received from the sensor module) to the user device, identifying objects of interest from the analysis video streams, generating user notifications based on the objects of interest, and sending the user notifications to the user device. The method can additionally include sending a background stream synchronized with the user stream. The user device preferably renders the user stream and the user notifications as they are received. In this variation, the user stream is preferably substantially up-to-date (e.g., a near-real time stream from the cameras), while the user notifications can be delayed (e.g., generated from past video streams).

e. User Interaction Latency Accommodation.

The method can additionally include accommodating user view changes at the user interface S600, as shown in FIG. 1. The user view can be defined by a viewing frame, wherein portions of the video stream (e.g., user stream, background stream, composite stream, etc.) encompassed within the viewing frame are shown to the user. The viewing frame can be defined by the client, the hub, the sensor module, the remote computing system, or any other suitable system. The viewing frame size, position, angle, or other positional relationship relative to the video stream (e.g., user stream, background stream, composite stream, etc.) can be adjusted in response to receipt of one or more user inputs. The viewing frame is preferably the same size as the user stream, but can alternatively be larger or smaller. The viewing frame is preferably centered upon and/or aligned with the user stream by default (e.g., until receipt of a user input), but can alternatively be offset from the user stream, aligned with a predetermined portion of the user stream (e.g., specified by pixel coordinates, etc.), or otherwise related to the user stream.

In a first variation, the viewing frame is smaller than the user stream frame, such that new positions of the viewing frame relative to the user stream expose different portions of the user stream.

In a second variation, the viewing frame is substantially the same size as the user stream frame, but can alternatively be larger or smaller. This can confer the benefit of reducing the size of the frame (e.g., the number of pixels) that needs to be de-warped and/or sent to the client, which can reduce the latency between video capture and user stream rendering (example shown in FIG. 15). In this variation, accommodating changes in the user view can include: compositing the user stream with a background stream into a composited stream; displaying the user stream on the user device; and translating the viewing frame over the composited stream in response to receipt of a user input indicative of moving a camera field of view at the user device, wherein portions of the background stream fill in gaps left in the user view by the translated viewing frame.

Compositing the streams can include overlaying the user stream over the background stream, such that one or more geographic locations represented in the user stream are substantially aligned (e.g., within several pixels or coordinate degrees) with the corresponding location represented in the background stream. The background and user streams can be aligned by pixel (e.g., wherein a first, predetermined pixel of the user stream is aligned with a second, predetermined pixel of the background stream), by geographic region represented within the respective frames, by reference object within the frame (e.g., a tree, etc.), or by any other suitable reference point. Alternatively, compositing the streams can include: determining the virtual regions missing from the user view (e.g., wherein the user stream does not include images of the corresponding physical region), identifying the portions of the background stream frame corresponding to the missing virtual regions, and mosaicking the user stream and the portions of the background stream frame into the composite user view. However, the streams can be otherwise composited. The composited stream can additionally be processed (e.g., run through 3D scene generation, example shown in FIG. 14), but can alternatively be otherwise handled. The streams are preferably composited by the displaying system (e.g., the user device), but can alternatively be composited by the hub, sensor module, or other system. The streams can be composited before the user input is received, after the user input is received, or at any other suitable time. The composited streams and/or frames can be synchronous (e.g., acquired at the same time), asynchronous, or otherwise temporally related. In one example, the user stream can be refreshed in near-real time, while the background stream can be refreshed at a predetermined frequency (e.g., once per second). However, the user stream and background stream can be otherwise related.

Translating the viewing frame relative to the user stream in response to receipt of the user input functions to digitally change the camera's field of view (FOV) and/or viewing angle. The translated viewing frame can define an adjusted user stream, encompassing a different sub-section of the user stream and/or composite stream frames. User inputs can translate the viewing frame relative to the user stream (e.g., right, left, up, down, pan, tilt, zoom, etc.), wherein portions of the background can fill in the gaps unfilled by the user stream.

User inputs (e.g., zoom in, zoom out) can change the scale of the viewing frame relative to the user stream (or change the scale of the user stream relative to the viewing frame), wherein portions of the background can fill in the gaps unfilled by the user stream (e.g., when the resultant viewing frame is larger than the user stream frame). User inputs can rotate the viewing frame relative to the user stream (e.g., about a normal axis to the FOV), wherein portions of the background can fill in the gaps unfilled by the user stream (e.g., along the corners of the resultant viewing frame). User inputs can rotate the user stream and/or composite stream (e.g., about a lateral or vertical axis of the FOV). However, the user inputs can be otherwise mapped or interpreted.

The user input can be indicative of: horizontal FOV translation (e.g., lateral panning), vertical FOV translation (e.g., vertical panning), zooming in, zooming out, FOV rotation about a lateral, normal, or vertical axis (e.g., pan/tilt/zoom), or any other suitable input. User inputs can include single touch hold and drag, single click, multitouch hold and drag in the same direction, multitouch hold and drag in opposing directions (e.g., toward each other to zoom in; away from each other to zoom out, etc.) or any other suitable pattern of inputs. Input features can be extracted from the inputs, wherein the feature values can be used to map the inputs to viewing field actions. Input features can include: number of concurrent inputs, input vector (e.g., direction, length), input duration, input speed or acceleration, input location on the input region (defined by the client on the user device), or any other suitable input parameter.

The viewing field can be translated based on the input parameter values. In one embodiment, the viewing frame is translated in a direction opposing the input vector relative to the user stream (e.g., a drag to the right moves the viewing field to the left, relative to the user stream). In a second embodiment, the viewing frame is translated in a direction matching the input vector relative to the user stream (e.g., a drag to the right moves the viewing field to the right, relative to the user stream). In a third embodiment, the viewing frame is scaled up relative to the user stream when a zoom out input is received. In a fourth embodiment, the viewing frame is scaled down relative to the user stream when a zoom in input is received. However, the viewing field can be otherwise translated.

In a first embodiment, user view adjustment includes translating the user view over the background stream. The background stream can remain static (e.g., not translate with the user stream), translate with the user view (e.g., by the same magnitude or a different magnitude), translate in an opposing direction than user view translation, or move in any suitable manner in response to receipt of the user input. In a first example, tilting the user view can rotate the user stream about a virtual rotation axis (e.g., pitch/yaw/roll the user stream), wherein the virtual rotation axis can be static relative to the background stream. In a second example, the user stream and background stream can tilt together about the virtual rotation axis upon user view actuation. In a third example, the background stream tilts in a direction opposing the user stream. However, the user stream can move relative to the background stream in any suitable manner.

In a second embodiment, user view adjustment includes translating the composited stream relative to the user view (e.g., wherein the user stream and background stream are statically related). For example, when the user view is panned or zoomed relative to the user stream (e.g., up, down, left, right, zoom out, etc.), such that the user view includes regions outside of the user stream, portions of the background stream (composited together with the user stream) fill in the missing regions.

However, the composited stream can move relative to the user view in any suitable manner.

As shown in FIG. 15, the method can additionally include: determining new processing instructions based on the adjusted user stream (e.g., by identifying the new parameters of the adjusted user stream relative to the raw stream, such as determining which portion of the raw frame to crop, what the tilt and rotation should be, what the transfer function parameters should be, etc.); transmitting the new processing instructions to the system generating the user stream (e.g., the sensor module, wherein the parameters can be transmitted through the hub to the sensor module); adjusting user stream generation at the user stream-generating system according to the new processing instructions, such that a second user stream having a different user view is generated from subsequent video frames; and transmitting the second user stream to the user device instead of the first user stream. The second user stream can then be subsequently treated as the original user stream. The new parameters (e.g., processing instructions) can additionally be stored by the sensor module, wherein subsequent sensor measurements can be processed based on the new parameters (e.g., for the specific client, all clients, etc.). The new parameters can additionally or alternatively be stored by the client and/or remote computing system as a preferred view setting. The client can automatically switch from displaying the composited first user stream to the second user stream in response to occurrence of a transition event. The transition event can be receipt of a notification from the sensor module (e.g., a notification that the subsequent streams are updated to the selected viewing frame), after a predetermined amount of time (e.g., selected to accommodate for new parameter implementation), or upon the occurrence of any other suitable transition event.

The new parameters are preferably determined based on the position, rotation, and/or size of the resultant viewing frame relative to the user stream, the background stream, and/or the composite stream, but can alternatively be otherwise determined. For example, a second set of processing instructions (e.g., including new cropping dimensions and/or alignment instructions, new transfer function parameters, new input pixel identifiers, etc.) can be determined based on the resultant viewing frame, such that the resultant retained section of the cropped video frame (e.g., new user stream) substantially matches the digital position and size (e.g., pixel position and dimensions, respectively) of the viewing frame relative to the raw stream frame. The new parameters can be determined by the client, the hub, the remote computing system, the sensor module, or by any other suitable system. The new parameters can be sent over the streaming channel, or over a secondary channel (e.g., preferably a low-power channel, alternatively any channel) to the sensor module and/or hub. However, user view changes can be otherwise accommodated.

f. System Update.

The method can additionally include updating the hub and/or sensor module S700, which functions to update the system software. Examples of software that can be updated include image analysis modules, motion correction modules, processing modules, or other modules; user interface updates; or any other suitable updates. Updates to the user interface are preferably sent to the client on the user device, and not sent to the hub or sensor module (e.g., wherein the client renders the user interface), but can alternatively be sent to the hub or sensor module (e.g., wherein the hub or sensor module formats and renders the user interface).

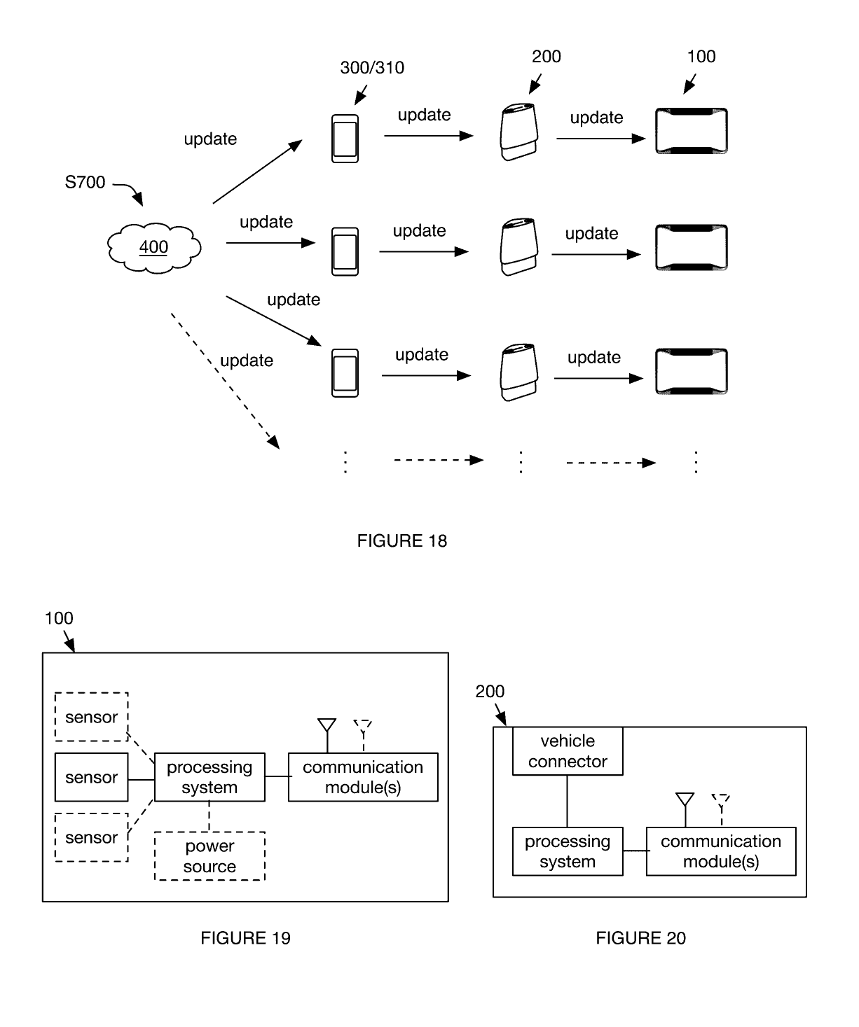

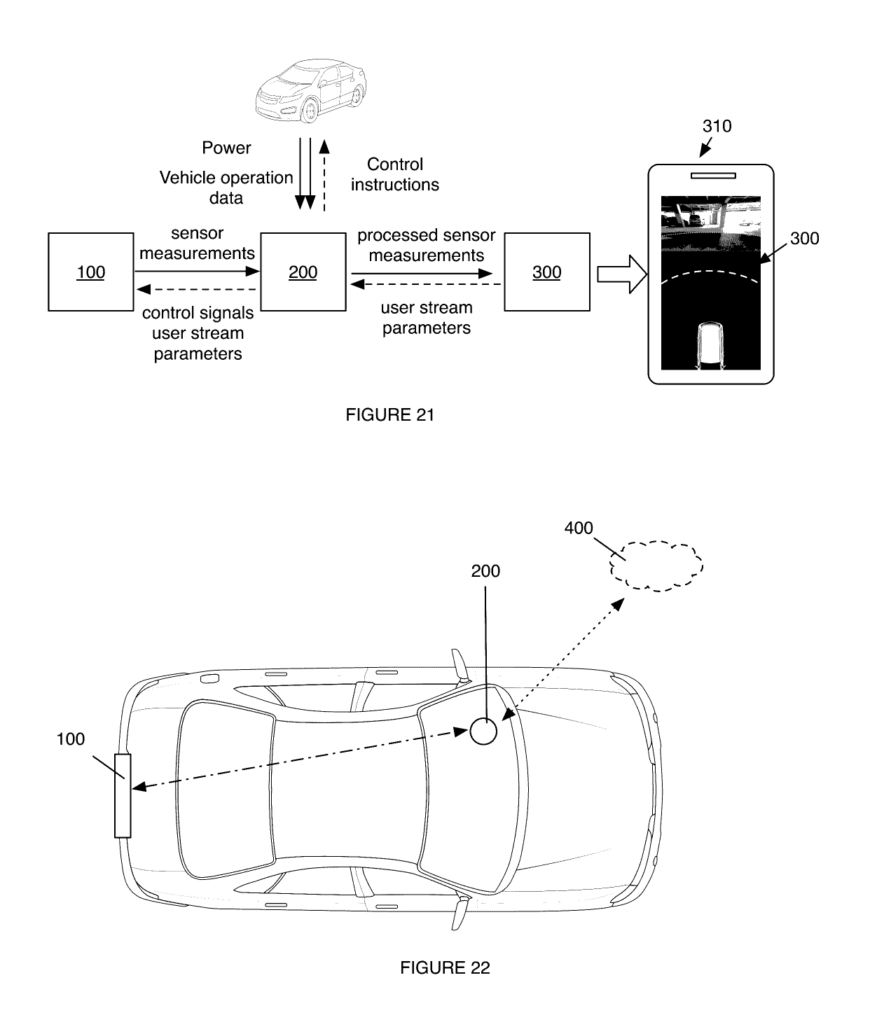

Updating the hub and/or sensor module can include: sending an update packet from the remote computing system to the client; upon (e.g., in response to) client connection with the hub and/or sensor module, transmitting the data packet to the hub and/or sensor module; and updating the hub and/or sensor module based on the data packet (example shown in FIG. 18). The data packet can include the update itself (e.g., be an executable, etc.), include a reference to the update, wherein the hub and/or sensor module retrieves the update from a remote computing system based on the reference; or include any other suitable information. Updates can be specific to a user account, vehicle system, hub, sensor module, user population, global, or for any other suitable set of entities. A system can be updated based on data from the system itself, based on data from a different system, or based on any other suitable data.

In a first variation, example shown in FIG. 7, updating the hub and/or sensor module includes: connecting to a remote computing system with the hub (e.g., through a cellular connection, WiFi connection, etc.) and receiving the updated software from the remote computing system.

In a second variation, updating the hub and/or sensor module includes: receiving the updated software at the client (e.g., when the user device is connected to an external communication network, such as a cellular network or a home WiFi network), and transmitting the updated software to the vehicle system (e.g., the hub or sensor module) from the user device when the user device is connected to the vehicle system (e.g., to the hub). The updated software is preferably transmitted to the hub and/or sensor module through the high-bandwidth connection (e.g., the WiFi connection), but can alternately be transmitted through a low-bandwidth connection (e.g., BLE or Bluetooth) or be transmitted through any suitable connection. The updated software can be transmitted asynchronously from sensor measurement streaming, concurrently with sensor measurement streaming, or be transmitted to the hub and/or sensor module at any suitable time. In one variation, the updated software is sent from the user device to the hub, and the hub unpacks the software, identifies software portions for the sensor module, and sends the identified software portions to the sensor module over a communication connection (e.g., the high-bandwidth communication connection, low-bandwidth communication connection, etc.). The identified software portions can be sent to the sensor module during video streaming, after or before video streamlining, when the sensor module state of charge (e.g., module SOC) exceeds a threshold SOC (e.g., 20%, 50%, 60%, 90%, etc.), or at any other suitable time.

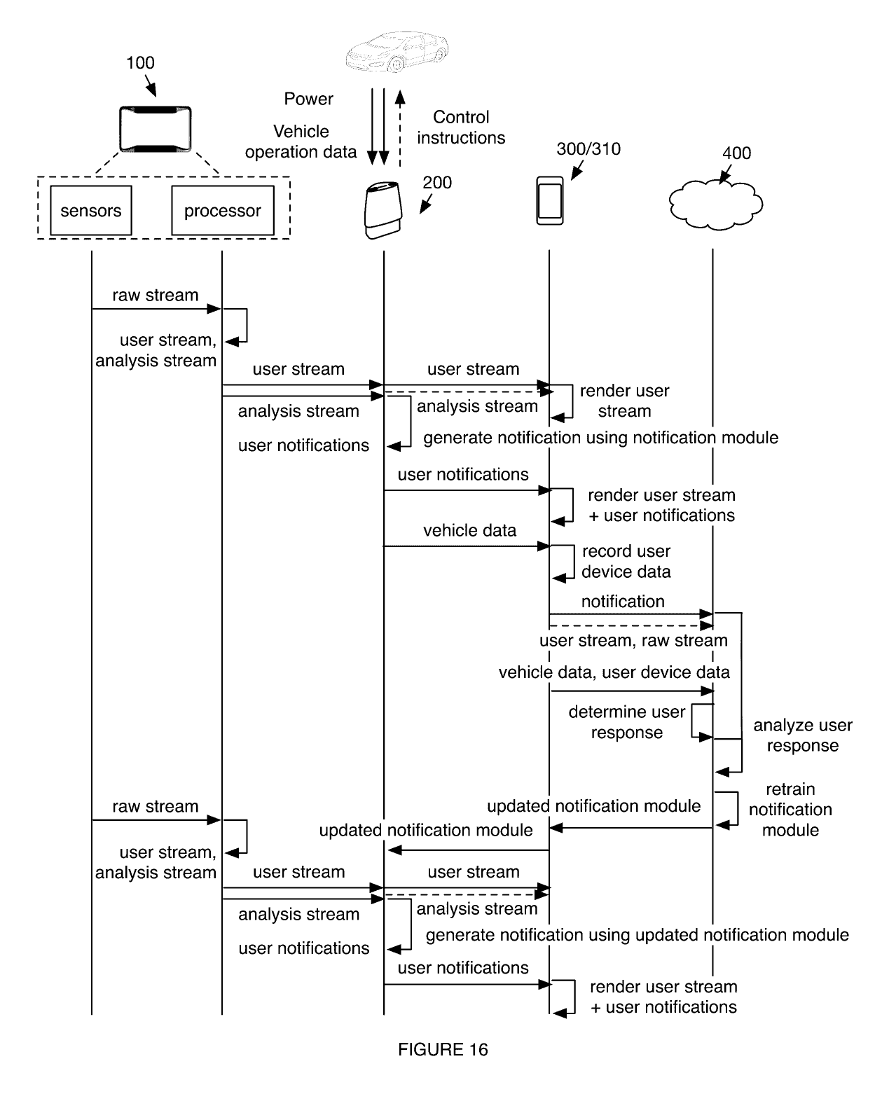

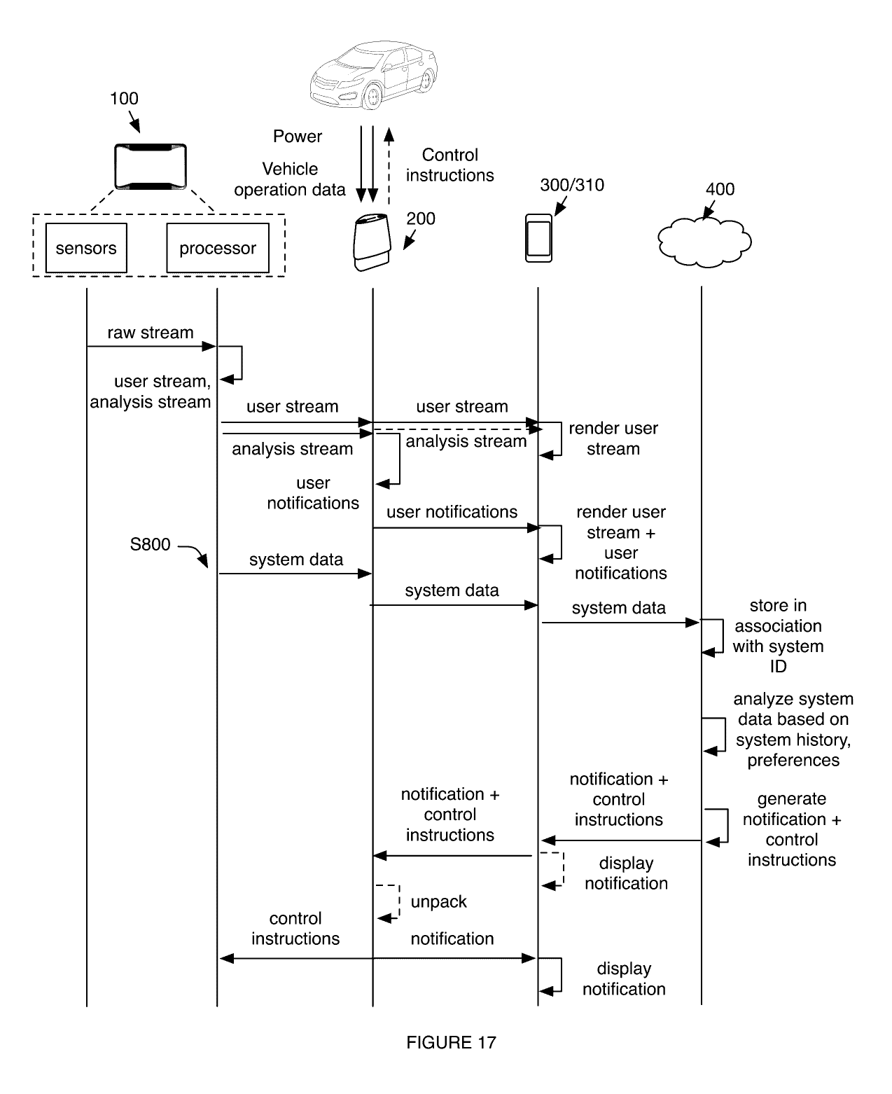

The method can additionally include transmitting sensor data to the remote computing system S800 (example shown in FIG. 17). This can function to monitor sensor module operation. The method can additionally include transmitting vehicle data, read off the vehicle bus by the hub; transmitting notifications, generated by the hub; transmitting user device data, determined from the user device by the client; and/or transmitting any other suitable raw or derived data generated by the system (example shown in FIG. 16). This information can be indicative of the user's response to notifications and/or user instructions, which can function to provide a supervised training set for processing module updates.

Sensor data transmitted to the remote computing system can include: raw video frames, processed video frames (e.g., dewarped, user stream, etc.), auxiliary ambient environment measurements (e.g., light, temperature, etc.), sensor module operation parameters (e.g., SOC, temperature, etc.), a combination of the above, summary data (e.g., a summary of the sensor measurement values, system diagnostics), or any other suitable information. When the sensor data includes summary data or a subset of the raw and derivative sensor measurements, the sensor module, hub, or client can receive and generate the condensed form of the summary data. Vehicle data can include gear positions (e.g., transmission positions), signaling positions (e.g., left turn signal on or off), vehicle mode residency time, vehicle speed, vehicle acceleration, vehicle faults, vehicle diagnostics, or any other suitable vehicle data. User device data can include: user device sensor measurements (e.g., accelerometer, video, audio, etc.), user device inputs (e.g., time and type of user touch), user device outputs (e.g., when a notification was displayed on the user device), or any other suitable information. All data is preferably timestamped or otherwise identified, but can alternatively be unidentified. Vehicle and/or user device data can be associated with a notification when the vehicle and/or user device data is acquired concurrently or within a predetermined time duration after (e.g., within a minute of, within 30 seconds of, etc.) notification presentation by the client; when the data pattern substantially matches a response to the notification; or otherwise associated with the notification.

The data can be transmitted asynchronously from sensor measurement streaming, concurrently with sensor measurement streaming, or be transmitted to the hub and/or sensor module at any suitable time. The data can be transmitted from the sensor module to the hub, from the hub to the client, and from the client to the remote computing system; from the hub to the remote computing system; or through any other suitable path. The data can be cached for a predetermined period of time by the client, the hub, the sensor module, or any other suitable component for subsequent processing.

In one example, raw and pre-processed sensor measurements (e.g., dewarped user stream) are sent to the hub, wherein the hub selects a subset of the raw sensor measurements and sends the selected raw sensor measurements to the client (e.g., along with the user stream). The client can transmit the raw sensor measurements to the remote computing system (e.g., in real-time or asynchronously, wherein the client caches the raw sensor measurements). In a second example, the sensor module sends sensor module operation parameters to the hub, wherein the hub can optionally summarize the sensor module operation parameters and send the sensor module operation parameters to the client, which forwards the sensor module operation parameters to the remote computing system. However, data can be sent through any other suitable path to the remote computing system, or any other suitable computing system.

The remote computing system can receive the data, store the data in association with a user account (e.g., signed in through the client), a vehicle system identifier (e.g., sensor module identifier, hub identifier, etc.), a vehicle identifier, or with any other suitable entity. The remote computing system can additionally process the data, generate notifications for the user based on the analysis, and send the notification to the client for display.

In one variation, the remote computing system can monitor sensor module status (e.g., health) based on the data. For example, the remote computing system can determine that a first sensor module needs to be charged based on the most recently received SOC (state of charge) value and respective ambient light history (e.g., indicative of continuous low-light conditions, precluding solar re-charging), generate a notification to charge the sensor module, and send the notification to the client(s) associated with the first sensor module. Alternatively, the remote computing system can generate sensor module control instructions (e.g., operate in a lower-power consumption mode, acquire less frames per second, etc.) based on analysis of the data. The notifications are preferably generated based on the specific vehicle system history, but can alternatively be generated for a population or otherwise generated. For example, the remote computing system can determine that a second sensor module does not need to be charged, based on the most recently received SOC value and respective ambient light history (e.g., indicative of continuous low-light conditions, precluding solar re-charging), even though the SOC values for the first and second sensor modules are substantially equal.

In a second variation, the remote computing system can train the analysis modules based on the data. For example, the remote computing system can identify a raw video stream, identify the notification generated based on the raw video stream by the respective hub, determine the user response to the notification (e.g., based on the subsequent vehicle and/or user device data; using a user response analysis module, such as a classification module or regression module, etc.), and retrain the notification module (e.g., using machine learning techniques) for the user or a population in response to the determination of an undesired or unexpected user response. The notification module can optionally be reinforced when a desired or expected user response occurs. In a second example, the remote computing system can identify a raw video stream, determine the objects identified within the raw video stream by the hub, analyze the raw video stream for objects (e.g., using a different image processing algorithm; a more resource-intensive image processing algorithm, etc.), and retrain the image analysis module (e.g., for the user or for a population) when the objects determined by the hub and remote computing system differ. The updated module(s) can then be pushed to the respective client(s), wherein the clients can update the respective vehicle systems upon connection to the vehicle system.

Each analysis module disclosed above can utilize one or more of: supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and any other suitable learning style. Each module of the plurality can implement any one or more of: a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naive Bayes, averaged one-dependence estimators, Bayesian belief network, etc.), a kernel method (e.g., a support vector machine, a radial basis function, a linear discriminate analysis, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial lest squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and any suitable form of machine learning algorithm. Each module can additionally or alternatively be a: probabilistic module, heuristic module, deterministic module, or be any other suitable module leveraging any other suitable computation method, machine learning method, or combination thereof.

Each analysis module disclosed above can be validated, verified, reinforced, calibrated, or otherwise updated based on newly received, up-to-date measurements; past measurements recorded during the operating session; historic measurements recorded during past operating sessions; or be updated based on any other suitable data. Each module can be run or updated: once; at a predetermined frequency; every time the method is performed; every time an unanticipated measurement value is received; or at any other suitable frequency. The set of modules can be run or updated concurrently with one or more other modules, serially, at varying frequencies, or at any other suitable time. Each module can be validated, verified, reinforced, calibrated, or otherwise updated based on newly received, up-to-date data; past data or be updated based on any other suitable data. Each module can be run or updated: in response to determination of a difference between an expected and actual result; or at any other suitable frequency.

An alternative embodiment preferably implements the above methods in a computer-readable medium storing computer-readable instructions. The instructions are preferably executed by computer-executable components preferably integrated with a communication routing system. The communication routing system may include a communication system, routing system and an analysis system. The computer-readable medium may be stored on any suitable computer readable media such as RAMs, ROMs, flash memory, EEPROMs, optical devices (CD or DVD), hard drives, floppy drives, server systems (e.g., remote or local), or any suitable device. The computer-executable component is preferably a processor but the instructions may alternatively or additionally be executed by any suitable dedicated hardware device.

Although omitted for conciseness, the preferred embodiments include every combination and permutation of the various system components and the various method processes.

As a person skilled in the art will recognize from the previous detailed description and from the figures and claims, modifications and changes can be made to the preferred embodiments of the invention without departing from the scope of this invention defined in the following claims.

We claim:

1. A method of operating a vehicle sensor management system, the system including: an imaging system configured to removably mount to a vehicle exterior, a processing system configured to removably connect to a data bus of the vehicle, and a client configured to run on a user device, the method comprising:
acquiring a raw video stream at the imaging system;
processing the raw video stream into a user stream and an analysis stream at the imaging system;
transmitting the analysis stream and the user stream from the imaging system to the processing system;
transmitting the user stream from the processing system to the client;
determining an ambient environment parameter for the vehicle, based on the analysis stream, at the processing system;
generating a notification based on the ambient environment parameter at the processing system;
transmitting the notification from the processing system to the client;
generating a composite video stream by overlaying graphics associated with the notification over the user stream; and
displaying the composite video stream at the client.

2. The method of claim 1, further comprising:
powering the imaging system using power from a first secondary battery, wherein the imaging system comprises the first secondary battery;
powering the processing system with power from the vehicle; and
powering the user device with power from a second secondary battery, wherein the user device comprises the second secondary battery.

3. The method of claim 1, wherein the analysis stream, user stream, and notification are transmitted between the imaging system, processing system, and client through a high bandwidth wireless communication network created by the processing system.

4. The method of claim 3, further comprising transmitting control instructions between the client, processing system, and the imaging system using a low bandwidth wireless communication protocol.

5. The method of claim 1, further comprising:
operating the imaging system in a low-power mode;
generating, at the processing system, a streaming control signal in response to occurrence of a streaming event;
transmitting the streaming control signal from the processing system to the imaging system;
operating the imaging system in a high-power mode in response to receipt of the streaming control signal, prior to acquiring the raw video stream;
generating, at the processing system, a termination control signal in response to occurrence a termination event;
transmitting the termination control signal from the processing system to the imaging system; and
operating the imaging system in the low-power mode in response to receipt of the termination control signal.

6. The method of claim 5, wherein the initialization event comprises wireless connection of the user device to the processing system, wherein the termination event comprises receiving data indicative of vehicle parking gear engagement at the processing system from the data bus.

7. The method of claim 1, wherein identifying the ambient environment parameter comprises identifying an object from the analysis stream, wherein the notification is determined based on a position of the object within a video frame.

8. The method of claim 1, wherein processing the raw video stream further comprises generating a cropped video stream, the cropped video stream comprising a retained section of each video frame of the video stream, the retained section defined by a set of cropping dimensions and a first set of orientation pixel coordinates, wherein the user stream comprises the cropped video stream.

9. The method of claim 8, further comprising:
receiving a user input at an input region defined by the client, the user input indicative of moving a camera field of view;
generating new cropping instructions based on the user input at the client, the new cropping instructions comprising a second set of orientation pixel coordinates different from the first set of orientation pixel coordinates; and
transmitting the new cropping instructions to the imaging system.

10. The method of claim 9, further comprising, at the client:
generating and displaying a second user stream based on the cropped video stream and the analysis stream until occurrence of a transition event; and
in response to occurrence of the transition event, displaying a second cropped video stream, generated by the imaging system and received from the processing system.

11. The method of claim 1, further comprising:
determining a software update at a remote server system;
transmitting a data packet, based on the software update, to the client from the remote server system;
in response to client connection with the processing system, transmitting the data packet to the processing system; and
updating the processing system based on the data packet.

12. The method of claim 11, wherein the data packet comprises the software update.

13. The method of claim 1, wherein the notification is generated from a first subset of video frames of the analysis stream, wherein the graphics are composited with video frames of the user stream generated from a second subset of video frames of the analysis stream, the second subset of video frames different from the first subset of video frames.

14. A vehicular guidance method using a guidance system including: an imaging system configured to removably mount to a vehicle exterior, the method comprising:
at the imaging system, concurrently recording a first and second raw video stream;
at the imaging system, processing the first raw video stream into a user stream;
transmitting the user stream to a client running on a user device;
determining an ambient environment parameter based on the first and second raw video streams;
generating a notification based on the ambient environment parameter;
transmitting the notification to the client;
at the client, generating a composite video stream by overlaying graphics associated with the notification over the user stream; and
presenting the composite video stream with the client on a display region of the user device.

15. The method of claim 14, wherein the notification is generated based on a first subset of video frames of the first raw video stream, wherein the graphics are composited with video frames of the user stream generated based on a second subset of video frames of the first raw video stream, the second subset of video frames different from the first subset of video frames.

16. The method of claim 14, wherein the user stream is transmitted over a high-bandwidth wireless communication network, wherein the client and imaging system are connected to the high-bandwidth wireless communication network.

17. The method of claim 14, further comprising processing the first and second raw video streams into a first and second analysis stream, respectively; and transmitting the first and second analysis stream to a processing system, wherein the processing system determines the ambient environment parameter based on the first and second raw video streams, generates the notification, and transmits the notification to the client.

18. The method of claim 17, wherein the processing system is housed in a separate housing from the imaging system and user device, the processing system configured to removably mount to a vehicle interior.

19. The method of claim 14, further comprising:
transmitting a first analysis stream, generated from the first raw video stream, to the user device;
at the user device:
generating a second composite video stream by aligning the user stream with the first analysis stream;
receiving a user input at an input region on the user device, the input region overlaying the display region, the user input comprising an input direction;
in response to receipt of the user input, determining an adjusted user video stream from the composite stream, the adjusted user video stream comprising a section of the second composite stream, shifted relative to the user video stream, along a direction opposing the input direction;
in response to receipt of the user input, sending user stream instructions, determined based on the user input, to the imaging system;
receiving and storing the user stream instructions at the imaging system;
concurrently recording a third and fourth raw video stream at the imaging system, the third and fourth raw video stream recorded after first and second raw video stream recordation;
processing the third raw video stream into a second user stream according to the user stream instructions at the imaging system; and
transmitting the second user stream to the client, wherein the client displays the second user stream at the display region.

20. The method of claim 14, further comprising:
recording imaging system operation parameters at the imaging system;
transmitting imaging system operation parameters to the client; and
transmitting the imaging system operation parameters to a remote server system from the client.
